(19) United States
(12) Patent Application Publication
(10) Pub. No.: US 2009/0124371 A1
(43) Pub. Date: May 14, 2009

(54) METHOD, APPARATUS, AND PROGRAM PRODUCT FOR CONDUCTING A VARIABLE PRIZE PROGRESSION GAME FOR ONE OR MORE PLAYERS

(76) Inventors: Jason C. Gilmore, Cedar Park, TX (US); Brian A. Watkins, Austin, TX (US); Todd D. Degani, Cedar Park, TX (US)

Correspondence Address: THE CULBERTSON GROUP, P.C., 1114 LOST CREEK BLVD., SUITE 420, AUSTIN, TX, 78746, US

(21) Appl. No.: 12/270,672

(22) Filed: Nov. 13, 2008

Related U.S. Application Data
(60) Provisional application No. 60/987,711, filed on Nov. 13, 2007.

(51) Int. Cl. A63F 9/24; A63F 13/00

(52) U.S. Cl. 463/27

(57) ABSTRACT

A game is provided including a prize progression graphic display at one or more gaming machines, each gaming machine being associated with a different player. The prize progression graphic includes a number of prize progressions with each respective prize progression including a respective prize and a respective set of progression segments. In one version, free spins are provided that produce, from the various players, a progress varying value or progression activation modifier. In another version, one of the prize progressions is shown in an active state. A number of selectable objects at each respective one of the one or more gaming machines, although other preferred forms of the game provides free spins rather than selectable objects. Each selectable object conceals a respective prize progression affecting element. Each respective prize progression affecting element comprises either a progress varying value or a progression activation modifier that modifies or changes the active state.

### CROSS-REFERENCE TO RELATED APPLICATION

The Applicants claim the benefit, under 35 U.S.C. §19(e), of U.S. Provisional Patent Application Ser. No. 60/987,711 filed Nov. 13, 2007, and entitled “Method, Apparatus, and Program Product for Conducting a Variable Prize Progression Game for One or More Players.” The entire content of this provisional application is incorporated herein by this reference.

### COPYRIGHT NOTICE

A portion of the disclosure of this patent document contains material which is subject to copyright protection. The copyright owner has no objection to the facsimile reproduction by any one of the patent documents or the patent disclosure, as it appears in the Patent and Trademark Office patent file or records, but otherwise reserves all rights of copyright.

### TECHNICAL FIELD OF THE INVENTION

This invention relates to gaming systems and to gaming machines through which players may participate in wagering games. More particularly, the invention relates to methods for conducting a game through a player interaction process that provides multiple prize progressions for one or more players and varies the prize progressions during the course of play.

### BACKGROUND OF THE INVENTION

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may employ one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. Video-based gaming machines may also be used to show card games or various types of competitions such as simulated horse races in which wagers may be placed. Game manufacturers are continuously pressed to develop new game presentations, formats, and game graphics in an attempt to provide high entertainment value for players and thereby attract and keep players.

### SUMMARY OF THE INVENTION

The present invention includes a highly entertaining method of conducting a game for one or more players. The entertainment value is achieved partially by displaying to the one or more players a variable prize progression graphic with which the players interact to ultimately obtain one or more prizes associated with the variable prize progression graphic. The present invention encompasses methods for operating one or more gaming machines as well as both apparatus and program products for implementing the gaming machine operation methods.

Because the present invention may allow more that one player to participate in a game in which each player may interact with a variable prize progression graphic, games conducted according methods encompasses by the present invention may be referred to as “multiplayer variable prize progression games.” However, it will be appreciated that some implementations of the present invention allow only a single player to participate in a given instance of multiplayer variable prize progression game. These games may still be referred to as multiple player prize progression games because they can accommodate multiple players even though a single player may participate in a given instance of the game. Also, for the sake of convenience in this disclosure “multiplayer variable prize progression games” will sometimes be referred to as “prize progression games.”

A method embodying principles of the invention may be implemented in a gaming machine using one or more display devices such as CRTs, LCDs, plasma displays, or other types of video display devices. The display device or devices are used to show the variable graphic elements according to the invention. It is also possible to show variable prize progressions according to the present invention using mechanical display devices or electro-mechanical display devices. As used in this disclosure and the accompanying claims, a gaming machine through which the present invention may be implemented will be referred to generally as a gaming machine regardless of the nature of the display device arrangement used to display portions graphical elements of the game to the player, and regardless of the manner in which the display device arrangement operates.

A method according to one form of the invention includes displaying a prize progression graphic at one or more gaming machines, each gaming machine being associated with a different player. The prize progression graphic includes a number of prize progressions, with each respective prize progression including a respective prize and a respective set of progression segments. One of the prize progressions is shown in an active state.

This form of the invention also includes displaying a number of selectable objects at each respective one of the one or more gaming machines, although other preferred forms of the game provides free spins rather than selectable objects. Each selectable object conceals a respective prize progression affecting element. Each respective prize progression affecting element comprises either a progress varying value or a progression activation modifier.

Each player in turn is enabled to select one of the selectable objects displayed at their respective gaming machine. In response to the player selection of a respective selectable object, the respective prize progression affecting element associated with the respective selectable object is revealed and the prize progression graphic is modified accordingly. That is, for each revealed progress varying value, the prize progression graphic is modified by varying the progress in the respective progression segments for the respective prize progression in the active state. For each revealed progression activation modifier, the prize progression graphic is modified by changing the respective prize progression in the active state.

A respective share of certain prizes is ultimately awarded to the participating players. In particular, the invention includes awarding each participating player the respective prize associated with each prize progression for which progress in the respective progression segments is completed at a termination of player selections.

Some forms of the invention further include detecting a triggering event to initiate the step of displaying the prize progression graphic for each of the one or more players. This triggering event may comprise a game play determination made by a server in communication with each of the one or more gaming machines.

In one form of the invention, at least one respective prize comprises a progressive prize. This progressive prize may be funded by a side bet which makes a respective gaming machine eligible for a variable prize progression game according to the invention.

In some forms of the invention, each player is enabled to make a specified number of selections of the selectable objects displayed at their respective gaming machine. Each player makes a single selection in turn until a selection termination state is reached. This state is achieved when each player has made their specified number of selections. However, a selection of at least one selectable object associated with a progress varying value does not reduce the specified number of selections for the respective player.

In some forms of the invention a side bet adds time to a countdown timer for a respective one of the gaming machines. The respective gaming machine is considered eligible for the prize progression game which is triggered by a game triggering event occurring while time remains on the countdown timer.

Some methods according to the invention further include displaying an additional selectable object at each respective gaming machine. The additional selectable object conceals an additional prize progression affecting element, which includes a progress varying value for a personal prize progression. This personal prize progression is displayed at the player's respective gaming machine. Other additional selectable objects displayed at the respective gaming machines may conceal an additional prize progression affecting element comprising either a personal credit prize, or a bank credit prize. All of the selectable objects or additional selectable objects displayed at each of the one or more gaming machines may be displayed in a random arrangement to help randomize the prize progression affecting elements that are ultimately revealed and applied to modify the prize progression graphic at each gaming machine.

A gaming system in one form of the invention includes a number of gaming machines, a game controller arrangement, and an award controller. Each gaming machine includes a display arrangement having one or more display devices, and also includes a player input device arrangement having one or more player input devices. The game controller arrangement causes the display arrangement for one or more of the number of gaming machines to display the prize progression graphic which includes a number of prize progressions, one of which is in an active state. Each respective prize progression is associated with a respective prize and a respective set of progression segments. The game controller arrangement also causes the display arrangement for the one or more of the number of gaming machines to display a number of selectable objects, each selectable object concealing a respective prize progression affecting element and each respective prize progression affecting element comprising either a progress varying value or a progression activation modifier. The game controller is further operative for enabling a player at each of the one or more gaming machines to select in turn one of the selectable objects displayed at their respective gaming machine. In response to the player selection of a respective selectable object, the game controller causes the respective prize progression affecting element associated with the respective selectable object to be revealed and causes the prize progression graphic to be modified accordingly. For each revealed progress varying value, the prize progression graphic is modified by varying the progress in the respective progression segments for the respective prize progression in the active state. For each revealed progression activation modifier, the prize progression graphic is modified by changing the respective prize progression in the active state. The award controller awards to each player a respective share of the respective prize associated with each prize progression for which progress in the respective progression segments is completed at a termination of player selections.

In one preferred form of the gaming system the game controller arrangement includes a game server and a respective game client at each one of the one or more gaming machines. The game server is in communication with each of the one or more gaming machines and functions to generating display control commands and communicate the display control commands to each of the one or more gaming machines. Each respective game client functions to respond to the respective display control commands communicated to the respective gaming machine.

The present invention may also be embodied in a program product stored in one or more computer readable media. One program product according to the invention includes prize progression display program code, selectable object display program code, player selection program code, game controller program code, and award program code. The prize progression display program code is executable for causing a display arrangement for one or more of a number of gaming machines to display a prize progression graphic as discussed above. The selectable object display program code is executable for causing the display arrangement for the one or more of the number of gaming machines to display a number of selectable objects as discussed above. The player selection program code is executable for enabling a player at each of the one or more gaming machines to select in turn one of the selectable objects displayed at their respective gaming machine. The game controller program code is executable for responding to the player selection of a respective selectable object to reveal the respective prize progression affecting element and directing the prize progression graphic at each of the one or more of the number of gaming machines to be modified accordingly as discussed above in connection with the methods. The award program code is executable for awarding to each player a respective share of the respective prize associated with each prize progression for which progress in the respective progression segments is completed at a termination of player selections.

These and other advantages and features of the invention will be apparent from the following description of the preferred embodiments, considered along with the accompanying drawings.

### BRIEF DESCRIPTION OF THE DRAWINGS

FIG. 1 is a view in front perspective of a gaming machine which may be used in a gaming system embodying the principles of the present invention.

FIG. 2 is a diagrammatic representation showing various electronic components of the gaming machine shown in FIG. 1.

FIG. 3 is a diagrammatic representation showing a network arrangement connecting a number of gaming machines according to one embodiment of the present invention.

FIG. 4 is a flow chart showing the general process of play at a gaming machine that includes a multi-player, variable prize progression bonus according to one embodiment of the invention.

FIG. 5 is a flow chart showing the process at a particular gaming machine during the conduct of multi-player, variable prize progression bonus game according to one embodiment of the invention.

FIG. 6 is a flow chart showing the operation of a game server in the conduct of a multi-player, variable prize progression game according to one embodiment of the invention.

FIG. 7 is a flow chart showing progressive prize functions for progressive prizes available in a multi-player, variable prize progression game according to one embodiment of the invention.

FIG. 8 is a representation of a graphic display showing an initial status of a prize progression graphic, and selectable objects, according to one embodiment of the invention at a respective gaming machine.

FIG. 9 is a representation of the graphic display shown in FIG. 8 as modified in response to selectable object selections.

FIG. 10 is a representation of the graphic display shown in FIG. 9 as modified in response to another selectable object selection and corresponding modification to the prize progression graphic.

FIG. 11 is a representation of the graphic display shown in FIG. 10 as modified in response to additional selectable object selections and showing a win indication.

FIG. 12A shows a flow chart of a process of activating a community bonus game according to another embodiment of the invention.

FIG. 12B shows flow chart of a general game process for the embodiment in FIG. 12A.

FIG. 13 shows a flow chart of a process that performed at a respective gaming machine during the conduct of a prize progression game.

FIG. 14 shows a block diagram of a process that may be performed at game server according to one preferred form of the invention, and represents the complement to the gaming machine process shown in FIG. 13.

FIG. 15 shows a sequence of data structures that may be used in a bonus game according to some embodiments of the invention.

FIG. 16 shows a table of awards according to one embodiment.

FIG. 17 shows a data structure for a progressive result pool according to one embodiment.

FIG. 18 is a flow chart and diagram of another process for generating free-spin results for the prize progression games described herein.

FIG. 19 shows an example of update data that is transmitted to gaming machines to update their bonus prize progression game status according to one embodiment of the invention.

FIG. 20 is a layout of a game screen for a reel-type base game according to the second embodiment described herein.

FIG. 21 is a layout of a game screen for a reel-type prize progression bonus game according to the second embodiment described herein.

### DESCRIPTION OF PREFERRED EMBODIMENTS

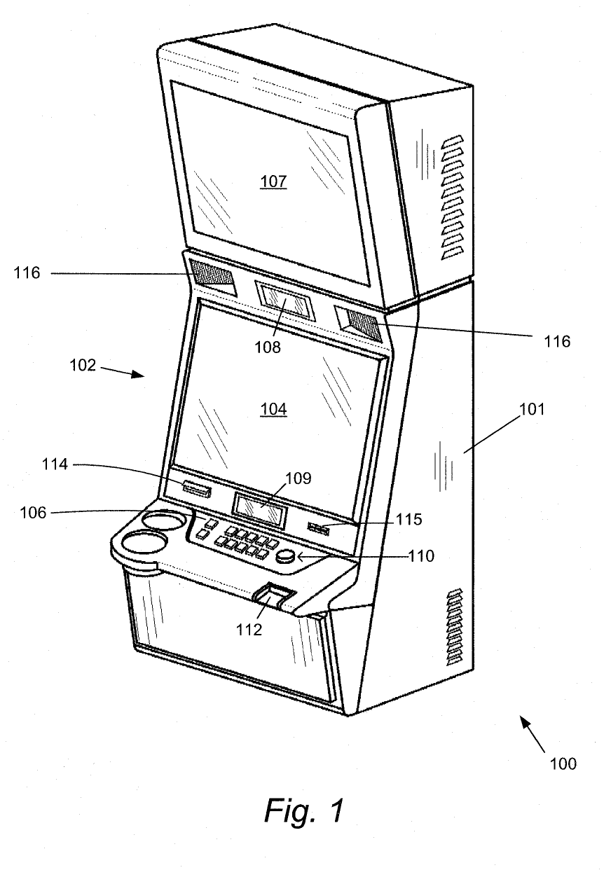

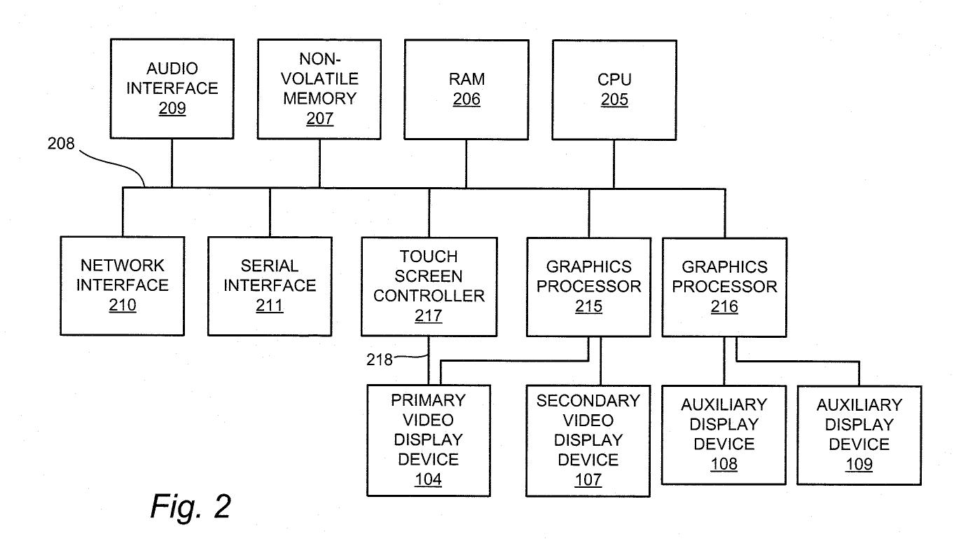

FIG. 1 shows a gaming machine 100 that may be used to implement a prize progression game according to the present invention. The block diagram of FIG. 2 shows further details of gaming machine 100. Referring to FIG. 1, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future.

Gaming machine 100, illustrated in FIG. 1, also includes a number of mechanical control buttons 110 mounted on ledge 106. These control buttons 110 may allow a player to select a bet level, select pay lines, select a type of game or game feature, and actually start a play in a primary game. Other forms of gaming machines according to the invention may include switches, joysticks, or other mechanical input devices, and/or virtual buttons and other controls implemented on a suitable touch screen video display. For example, primary video display device 104 in gaming machine 100 provides a convenient display device for implementing touch screen controls.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Numerous other types of devices may be included in gaming machines that may be used according to the present invention.

FIG. 2 shows that gaming machine 100 includes a central processing unit (CPU) 205 along with random access memory 206 and nonvolatile memory or storage device 207. All of these devices are connected on a system bus 208 with an audio interface device 209, a network interface 210, and a serial interface 211. A graphics processor 215 is also connected on bus 208 and is connected to drive primary video display device 104 and secondary video display device 107 (both mounted on cabinet 101 as shown in FIG. 1). A second graphics processor 216 is also connected on bus 208 in this example to drive the auxiliary display devices 108 and 109 also shown in FIG. 1. As shown in FIG. 2, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements are preferably mounted on a standard personal computer chassis and housed in a standard personal computer housing which is itself mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 2 as being connected directly on system bus 208 may in fact communicate with the other system components through a suitable expansion bus. Audio interface 209, for example, may be connected to the system via a PCI bus. System bus 208 is shown in FIG. 2 merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, it will be appreciated that CPU 205 may control all of the display devices directly without any intermediate graphics processor. The invention is not limited to any particular arrangement of processing devices for controlling the video display devices included with gaming machine 100. Also, a gaming machine implementing the present invention is not limited to any particular number of video display device or other types of display devices, provided some display arrangement is included for displaying the prize progression graphic, the selectable objects, and the display modifications resulting from the selection of the various selectable objects.

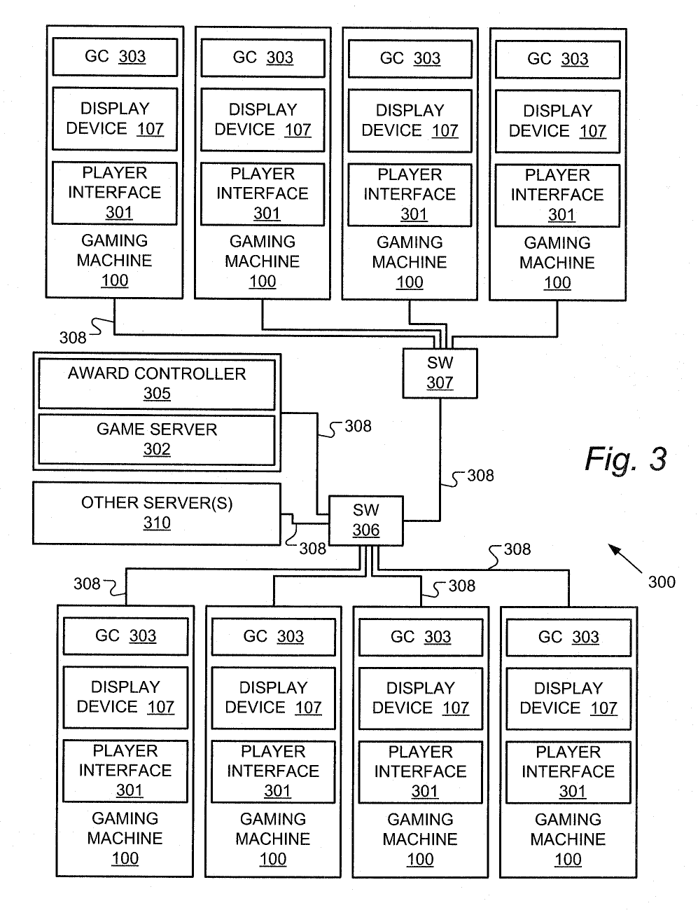

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine and may also implement a game client for directing one or more display devices at the gaming machine to display portions of a prize progression game according to the present invention. CPU 205 also executes software related to communications handled through network interface 210, and software related to various peripheral devices such as those connected to the system through audio interface 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of gaming machine operation. Network interface 210 provides an interface to other components of a gaming system in which gaming machine 100 is included. In particular, network interface 210 provides an interface to a game server which controls certain aspects of the multiplayer, variable prize progression game as will be discussed below in connection with FIG. 3.

It should be noted that the invention is not limited to gaming machines employing the personal computer-type arrangement of processing devices and interfaces shown in example gaming machine 100. Other gaming machines through which a variable prize progression game is implemented may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is possible to implement a variable prize progression game within the scope of the present invention using an electro mechanical arrangement or even a purely mechanical arrangement for displaying the prize progression graphic, the selectable objects, and the display modifications resulting from the selection of the various selectable objects. However, the most preferred forms of the invention utilize one or more video display devices for displaying the prize progression graphic, the selectable objects, and the display modifications resulting from the selection of the various selectable objects. For example, a gaming machine suitable for providing a variable prize progression game may include a mechanical reel-type display rather than a video-type display device for displaying results in a primary game, and include a video display device for presenting the variable prize progression game as a bonus game. Thus, a gaming machine suitable for use in the present invention may have a structure similar to that shown for gaming machine 100 in FIG. 1, but with a mechanical reel-type display replacing the primary video display device 104, and the video display device 107 being used for displaying the prize progression graphic, the selectable objects, and the display modifications resulting from the selection of the various selectable objects.

Referring now to FIG. 3, a gaming system 300 according to the present invention includes a number of gaming machines, each comprising a gaming machine 100 in this example implementation. For purposes of describing system 300, each gaming machine 100 in FIG. 3 is shown as including a video display device 107 and a player interface that may include buttons, switches, or other physical controls and/or touch screen controls as discussed above in connection with FIG. 1. This player interface is labeled 301 in FIG. 3. System 300 further includes a game server 302 and a respective game client 303 (abbreviated “GC” in FIG. 3) included with each respective gaming machine 100. In the form of the invention shown in FIG. 3 these two components, game server 302 and the game client components 303 combine to implement a game control arrangement which will be described in detail below. System 300 also includes an award controller 305, which is shown in FIG. 3 as being associated with game server 302 to indicate that the two components may be implemented through a common data processing device/computer system. Gaming machines 100, game server 302, and award controller 305 are connected in a network communication arrangement including first and second network switches 306 and 307, connected together through various wired or wireless signal paths, all shown as communications links 308 in FIG. 3.

Each gaming machine 100, and particularly player interface 301 associated with each gaming machine, allows a player to make any inputs that may be required to make the respective gaming machine eligible for a prize progression game, and make selection of selectable objects displayed at the respective gaming machine in the course of a prize progression game. Player interface 301 also allows a player at the gaming machine to initiate plays in a primary game available through the gaming machine in some implementations. The respective video display device 107 associated with each respective gaming machine 100 is used according to the invention to generate the graphic displays to show the various elements of a prize progression game at the respective gaming machine.

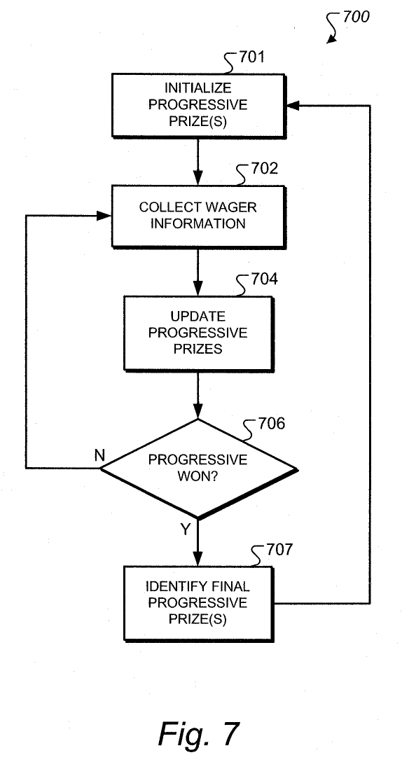

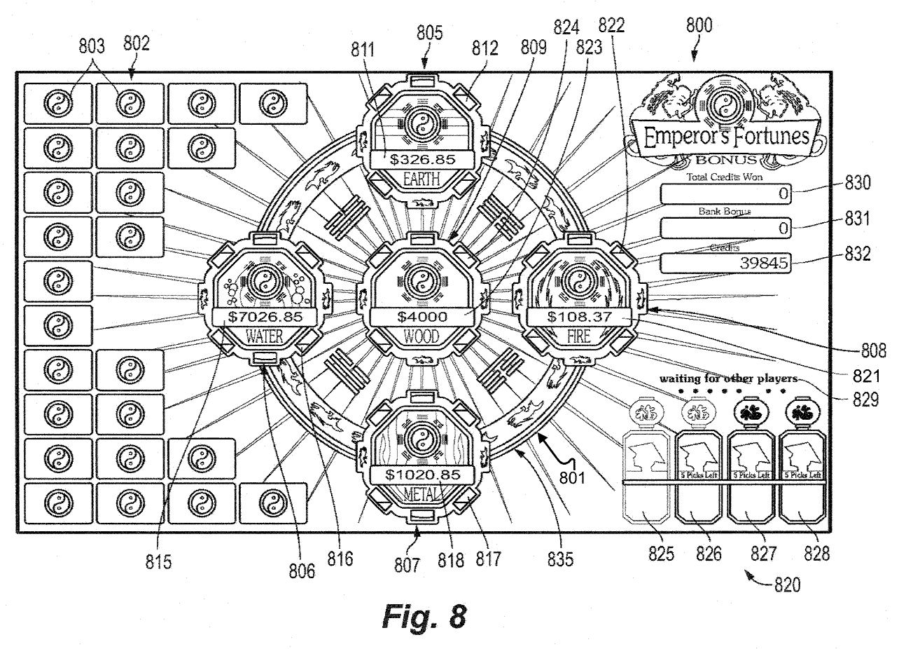

The game control arrangement made up of game server 302 and the respective game client 303 at a given gaming machine functions to control the respective video display device 107 for that gaming machine to display a prize progression graphic and a number of selectable objects. Various characteristics of a prize progression graphic and selectable objects according to the invention will be described below in connection with the example of FIGS. 8-11. Award controller 305 is responsible for awarding prizes for a player's participation in a prize progression game, and maintaining progressive prize information where the prize progression game offers one or more progressive prizes. Further details regarding prizes that may be available in a prize progression game according to the present invention will be described below in connection with FIG. 7.

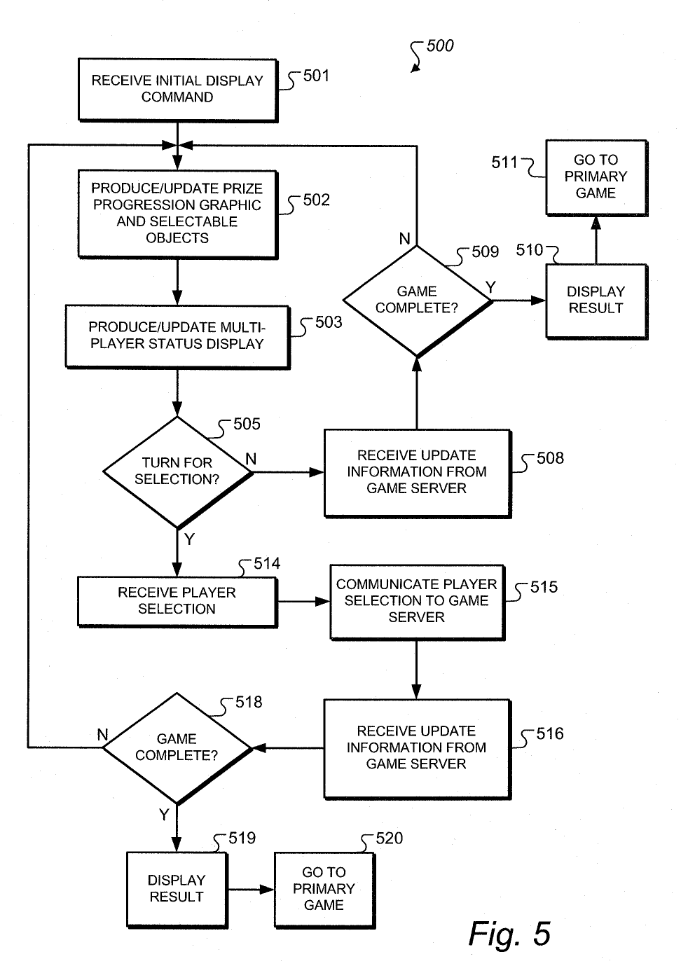

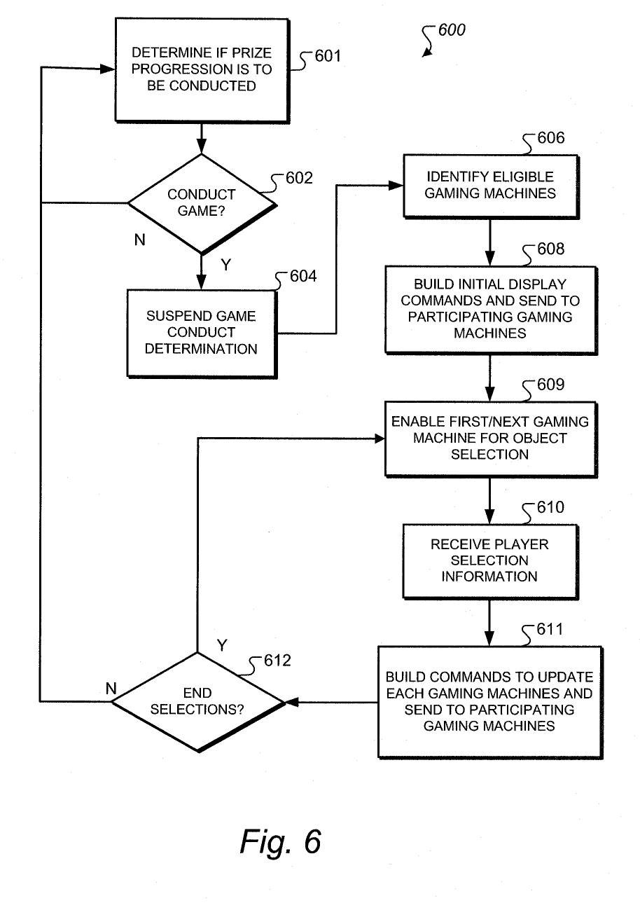

As will be described further below in connection with the flow diagrams of FIGS. 5 and 6, the present invention requires various communications between game server 302 and the various gaming machines 100 included in system 300. The network arrangement made up of network switches 306 and 307, and the various communication links 308 shown in FIG. 3 is illustrated merely as an example of a suitable communications arrangement. The present invention is not limited to any particular communications arrangement for facilitating communications between game server 302 and various gaming machines 100. Any wired or wireless communication arrangement employing any suitable communications protocols (such as TCP/IP for example) may be used in an apparatus according to the invention.

The example system 300 shown in FIG. 3 shows two different groups of four gaming machines 100. The example game described below in connection with FIGS. 8-11, allows from one to four gaming machines to participate in a given instance of a prize progression game according to the invention. However, the invention is not limited to any particular number of gaming machines that may participate in a prize progression game. Some preferred embodiments limit the number to a relatively small number so as to minimize the delay between player selections at a given gaming machine as other players take their respective selection turn as will be discussed further below (for versions of the invention in which players take turns). Also, the gaming machines that may participate in a given instance of a prize progression game may be selected or grouped in any suitable fashion. In one preferred embodiment, all gaming machines that may participate in a prize progression game may be statically grouped together and when it is determined that a prize progression game will be conducted for a respective static group of gaming machines, only those in the group that are then eligible for the prize progression game are actually enabled to participate in the instance of the game. In other preferred forms of the invention, gaming machines 100 in system 300 may be dynamically grouped so that there is no fixed groupings of gaming machines to participate in any given instance of a prize progression game. The dynamic grouping may be performed by a network component such as game server 302 and may be preformed to as to ensure that as many of the instances of the prize progression game as possible are conducted with the maximum number of gaming machines participating.

FIG. 3 shows other server(s) 310 included in the network. This illustrated “other server(s)” element 310 may include one or more data processing devices for performing various functions related to games conducted through system 300 and any other games that may be available to players through gaming machines 100. For example, apparatus 300 may provide support for cashless gaming or various forms of mixed cash/cashless gaming through the various gaming machines 100. In this example, one more other servers 310 will be included in apparatus 300 for supporting these types of wagering and payout systems. As another example, the various gaming machines 100 included in system 300 may allow players to participate in a game (primary game) other than a prize progression game, and this other game may rely on a result identified at or in cooperation with a device that is remote from the gaming machines. In this example, another server 310 may be included in the system for identifying results for the primary game and communicating those results to the various gaming machines 100 as necessary. Generally, the other server(s) 310 shown in FIG. 3 are shown only to indicate that numerous other components may be included along with the elements that participate in providing prize progression games according to the present invention. Other server(s) 310 may provide record keeping, player tracking, accounting, or result identifying services, or any other services that may be useful or necessary in a gaming system.

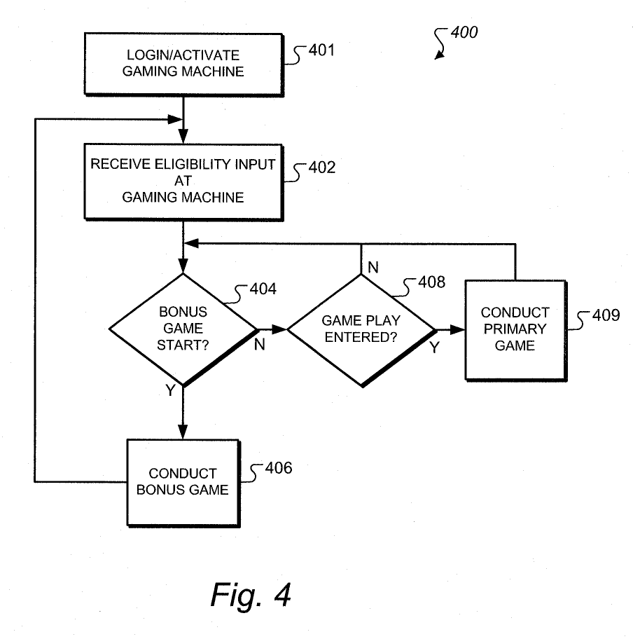

FIG. 4 shows a process 400 that may be performed at the various gaming machines 100 included in the gaming system shown in FIG. 3. In particular, process 400 illustrates the interaction between a primary game that may be available at a respective gaming machine 100, and a multi-player, variable prize progression game implemented as a bonus game through the gaming machine. Once the player logs in at gaming machine 100 or otherwise activates the gaming machine as indicated at process block 401, the player may make a suitable eligibility input at the gaming machine as indicated at process block 402. If a bonus game is started as indicated by a positive outcome at decision box 404, the process proceeds to conduct a bonus game as indicated at process block 406. This bonus game may comprise a prize progression game according to the present invention. Once the bonus game is completed, the process loops back to receive any other eligibility input as necessary. If the bonus game is not starting for the respective gaming machine 100 as indicated by a negative outcome at decision box 404, the process proceeds to conduct a primary game as indicated at process block 409 in the event that a primary game initiating input, that is, a “game play,” has been entered as indicated by a positive outcome at decision box 408. If a game play has not been entered at the gaming machine, process loops back to determine if the bonus game is to start.

Process 400 shown in FIG. 4 is a simplified process included in this disclosure to indicate that gaming machine 100 may require an eligibility input in order to be entitled to participate in a prize progression game according to the present invention. In one preferred embodiment, a gaming machine may be made eligible for the prize progression game by placing a suitable side bet at the gaming machine. In this embodiment, a particular side bet entered at the respective gaming machine 100 makes the gaming machine eligible for a bonus game that starts within a fixed period of time after the side bet. The respective gaming machine 100 may maintain a countdown timer showing the time of eligibility remaining. The respective gaming machine 100 may include a component that monitors the eligibility time remaining and, when the eligibility time is about to expire, produce a suitable prompt for the player providing a suitable indication to that effect and providing the player an opportunity to renew the eligibility by making another side bet.

It will be appreciated by those skilled in the art that eligibility may be handled in a number of ways within the scope of the present invention. Also, some forms of the invention may not require a separate eligibility input but instead may make a given gaming machine eligible in response to a particular bet level in the primary game. In yet other forms of the invention, all gaming machines may be automatically eligible for participation in a prize progression game, and no eligibility inputs are necessary to participate in such a game.

It should be noted that process 400 in FIG. 4 assumes that the prize progression game is conducted as a bonus game at a gaming machine that also offers a primary game that the player may play in between prize progression games. However, the invention is not limited to the implementation of a multiplayer variable prize progression game as a bonus game. In particular, a prize progression game may be implemented as a primary game at gaming machine 100, and may be offered with or without any bonus or secondary games.

FIG. 5 shows a process 500 that may be performed at a respective gaming machine 100 during the conduct of a prize progression game, whether conducted as a bonus game as indicated at process block 406 in FIG. 4 or otherwise. In process 500 the respective gaming machine 100 receives an initial display command at the start of a particular prize progression game. After receiving the initial display command as indicated at process block 501, gaming machine 100 displays the prize progression graphic and selectable objects at the gaming machine as indicated at process block 502. That is, the respective gaming machine 100 causes the desired display device or devices at the gaming machine to display the prize progression graphic and selectable objects. The illustrated process also includes displaying a multiplayer status indicator as shown at process block 503.

If it is not presently the particular player's turn for selecting a selectable object as indicated by a negative outcome at process decision box 505, the respective gaming machine 100 waits to receive update information on the prize progression graphic and multiplayer status indicator as indicated at process block 508. If the game is complete at this point as indicated by a positive outcome at decision box 509 the gaming machine displays the result for the prize progression game as indicated at process block 510. Where the prize progression game is being played as a bonus game at the respective gaming machine 100, the process returns to the primary game as shown at process block 511. If the game is not complete as indicated by a negative outcome at decision block 509, the process loops back to proceed again through process blocks 502 and 503 to the decision at decision box 505.

During some cycles through process blocks 502 and 503, it will be the player's turn (that is, the player at that respective gaming machine) to make a selection of a selectable object in the game. In this case, the outcome at decision box 505 will be positive. Upon a positive outcome at decision box 505, the process proceeds to receive the player selection as shown at process block 514. Once the player selection is received at the respective gaming machine 100, the gaming machine communicates the player selection to game server 302 (FIG. 3) as indicated at process block 515 and waits for update information from the game server. Once the update information is received from game server 302 as shown at process block 516, another determination is made as to whether the game is complete. If the game is complete as indicated by positive outcome at decision box 518, the process proceeds to display the result as indicated at process block 519, and then return control to the primary game as shown at process block 520. If the game is not complete as indicated by a negative outcome at decision box 518, the process loops up to proceed again through process blocks 502, 503, and decision box 505.

Process 500 shown in FIG. 5 represents one preferred process conducted at a respective gaming machine 100 for an implementation of a prize progression game as implemented through a gaming system as shown in FIG. 3. In this preferred form of the invention the functions of the gaming machine in the prize progression game all relate producing various displays and modifications to the graphic displays in response to information received from game server 302. Other forms of prize progression games within the scope of the present invention may distribute functions differently across the network. In particular, rather than rely exclusively on information provided by game server 302 as indicated in process 500, the respective gaming machine 100 may act on at least some information available to the gaming machine without any communication with the game server.

The type of information received in the initial display command as indicated at process block 501 may include any initial information necessary to allow the respective gaming machine 100 to display the desired prize progression graphic in its initial state and to display the selectable objects in their initial state according to the process at process block 502. The respective gaming machine 100 may store certain graphic information used to produce the desired graphic displays, however, information on the state of any variable aspects of the prize progression graphic are obtained from game server 302 according to process 500 shown in FIG. 5. For example, although the basic graphic elements for a particular prize progression graphic may be stored at the respective gaming machine 100 and retrieved to help produce the desired graphic displays, variable prize values such as progressive prize values may be included in the information making up the initial display command received at process block 501.

The update information received from game server 302 as indicated at process block 508 may include numerous types of information that affects the prize progression graphic displayed at the gaming machine. For example, in their turn to select one of the selectable objects displayed at their respective gaming machine, another player may select an object associated with a progression activation modifier. In this case, the information received at process block 508 comprises information that allows the respective gaming machine 100 to modify the prize progression graphic to show the correct prize progression in the active state. As another example, a player in their turn at another gaming machine may select a selectable object associated with a progress varying value that has the effect of varying the progress for one of the prize progressions in the prize progression graphic displayed at each gaming machine 100. In this case, the information received at process block 508 comprises information necessary to allow the respective gaming machine 100 to show the updated progress for the given prize progression.

In gaming machine process 500 shown in FIG. 5, the respective gaming machine 100 requires information from game server 302 even for player selections made at that particular gaming machine. For example, although the respective gaming machine 100 may be able to detect a player selection of a particular selectable object, it may rely on information from game server 302 as to what, if any, prize progression affecting element is to be revealed by virtue of the selection of that particular selectable object. Continuing with this example, gaming machine 100 may communicate to game server 302 information indicating which player selectable object has been selected. This is the communication indicated at process block 515 in FIG. 5. Game server 302 may use this information to identify a particular prize progression affecting element associated with that selectable object as will be described further below. The gaming machine 100 receives the prize progression affecting element information as indicated at process block 516 and then uses that information to update the prize progression graphic at process block 502. The update may involve switching which respective prize progression is in the active state or modifying the progress for a given one or more of the prize progressions.

As will be discussed further below, for example in connection with the specific example shown in FIGS. 8-11, a prize progression game according to the invention may include personal credit prizes for a given gaming machine 100 participating in the game, as well as bank credit prizes. Also, one or more of the prize progressions included in the prize progression graphic may comprise a prize progression that is personal to the particular player at that gaming machine in the sense that only that player can affect the progress through the prize progression and only that player may win a prize for completing that prize progression. Other prize progressions displayed at that gaming machine may be shared in the sense that all of the player's share in advancing through the various segments of that prize progression and also share in any prize associated with the completion of that prize progression. Each player may have their own personal prize progression, or only some of the players in a given multiplayer variable prize progression game may have one or more personal prize progressions.

As will also be discussed further below, for example in connection with the example game shown in FIGS. 8-11, a prize progression game according to the present invention preferably utilizes a multiplayer status indicator display at each gaming machine to indicate the status of play in the game. Initially displaying and updating this multiplayer status indicator is shown at process block 503 in FIG. 5. This status indicator may indicate which player participating in the game may then select one of the selectable objects displayed at their respective gaming machine 100. This multiplayer status indicator may also indicate the last prize progression affecting element that each respective player has cause to be revealed. Game server 302 preferably maintains information on the status of the game and communicates that status information as necessary to the gaming machine at process blocks 508 and 516 in FIG. 5 in order to provide the gaming machine with sufficient information to display or update the multiplayer status indicator at process block 503.

The process 600 shown in FIG. 6 may be performed at game server 302 shown in FIG. 3 according to one preferred form of the invention, and represents the complement to the gaming machine process 500 shown in FIG. 5. As indicated at process block 601, game server 302 is preferably responsible for making a determination as to whether a prize progression game is to be conducted. Process 600 assumes that the determination is conducted periodically at process block 601. Thus a negative outcome at decision box 602 causes the process to loop back to wait for the next determination at process block 601. If a prize progression game is to be conducted as indicated by a positive outcome at process block 602, the process proceeds to suspend any further game conduct determinations as indicated at process block 604. Process 600 then identifies eligible gaming machines as indicated at process block 606, and then proceeds to build initial display commands and send the initial display commands to the participating gaming machines as indicated at process block 608. As indicated at process block 609, game server 302 causes a respective gaming machine 100 participating in the game to be enabled for an object selection, and then receive this player selection information at process block 610. Game server 302 then builds update commands for each participating gaming machine 100, and then causes those update commands to be sent to the respective gaming machines as indicated that process block 611. If further selections of selectable objects are available for any of the participating players, as indicated by positive outcome at decision box 612, the process loops back to process block 609 at which point a next gaming machine 100 is enabled so that the player at that gaming machine may select one of the selectable objects displayed at that gaming machine. If no further selections are available as indicated by negative outcome at decision box 612, the process returns to the step shown at process block 601 to reinitiate the determination step indicated there.

The process 600 shown in FIG. 6 represents a process conducted for a single instance of a prize progression game according to one form of the present invention. That is, this process is performed for each prize progression game that is conducted. Some implementations according to the invention allow game server 302 to conduct only one instance of a prize progression game at a time. However, other preferred implementations may allow multiple instances of the prize progression game to be conducted at a given time either up to the physical hardware limit or some imposed limit.

The determination shown at process block 601 in FIG. 6 may be made in any suitable fashion. Regardless of the particular implementation, the determination is preferably controlled to evenly distribute prize progression games across some number of gaming machines controlled through game server 302. In other forms of the invention, the determination may be skewed in some fashion to encourage certain conduct by the players through the reward of more frequent participation in prize progression games.

FIG. 7 illustrates a process that may be conducted at game server 302 or award controller 305 (FIG. 3), or some other device in a gaming system according to the invention for maintaining information on progressive prizes that may be available in a prize progression game. Process 700 includes first initializing progressive prizes as indicated at process block 701. This may include producing a data record with a seed amount for the various progressive prizes that may be available. After initialization, the process collects wager information as indicated at process block 702. The collected wager information is used to update progressive prizes as shown at process block 704. If no progressive prize is won as indicated by negative outcome at decision box 706, the process loops back to collect further wager information at process block 702. Otherwise, if a progressive prize has been won as indicated by positive outcome at decision boxes 706, the process identifies the final progressive prizes or prize as indicated at process block 707, the process then returns to the initialization step to reinitialize each progressive prize that has been won.

The progressive information collected and maintained according to process 700 is maintained available to game server 302 in the form of a mention shown in FIG. 3. Game server 302 may access this information to build appropriate update commands according to process block 611 in FIG. 6 or build initial display commands as indicated at process block 608 in FIG. 6.

Progressive prize or prizes may be updated as indicated at process block 704 in FIG. 7 in any suitable fashion. One preferred form of the invention which is illustrated in FIGS. 8-11 includes multiple progressive prizes that are each funded by a side bet that enables a respective gaming machine to participate in a prize progression game according to the invention. Each side bet is collected as indicated at process block 702 in FIG. 7 and then an allocation formula is applied to the bet to allocate the bet between different progressive prize pools for the various progressive prizes. A portion of the side bet may also be allocated to the house. As will be discussed below in connection with the specific example game, some of the progressive prizes may be more difficult to win than others according to the rules of the game. The allocation formula may allocate the bets to produce a desirable distribution of available progressive prizes, including one or more relatively high value progressive prizes to encourage participation in the prize progression games.

FIG. 8 comprises a graphic representation 800 that may be displayed at a given gaming machine in the course of a prize progression game according to the present invention. Graphic representation 800 includes a prize progression graphic shown generally at reference numeral 801, and a set 802 of selectable objects 803. Prize progression graphic 801 includes five different prize progressions, 805, 806, 807, 808, and 809. Each prize progression 806-809 is associated with a respective prize and a set of progression segments. In particular, prize progression 805 includes prize 811 and a set of progression segments made up of segments 812, prize progression 806 includes prize 815 and a set of progression segments made up of segments 816, and prize progression 807 includes prize 818 and a set of progression segments made up of segments 817. Additionally, prize progression 808 includes prize 821 and a set of progression segments made up of segments 822, and prize progression 809 includes prize 823 and a set of progression segments made up of segments 824.

In addition to prize progression graphic 801 and selectable object set 802, graphic representation 800 also includes a multiplayer status indicator graphic generally shown at 820. This multiplayer status indicator graphic 820 includes a different location 825, 826, 827, and 828 representing each player that may participate in a given instance of the prize progression game. Multiplayer status indicator graphic 820 also includes an area for a status message 829. Each different location 825, 826, 827, and 828 includes an indication of the ‘number of selections left’ in the game for the associated player. Immediately below the ‘number of selections left’ message is an area of the respective location 825, 826, 827, and 828 reserved for displaying an indication of the prize progression affecting element revealed by the most recent selection by that player. Graphic representation 800 also shows a total credits won meter 830, a bank bonus meter 831, and a credits meter 832.

Graphic representation 800 shows an initial state of prize progression graphic 801 and selectable object set 802. Multiplayer status indicator graphic 820 indicates that only three players are participating in this particular instance of the prize progression game as indicated by the normal graphic appearance of locations 826-828. The grayed out appearance for location 825 indicates that this location is not associated with a participating player in this instance of the prize progression game. Multiplayer status indicator graphic 820 also highlights the particular location for the player having the current turn to make a selection of a selectable object appearing on that players particular graphic. In the state shown in FIG. 8, location 826 is highlighted to show that it is that player's turn to make a selection, however the player has not yet made a selection in the illustrated state.

In this illustrated game a graphic representation having the same general structure as graphic representation 800 is displayed at each gaming machine (such as gaming machine 100) participating in the particular instance of the prize progression game. Some of the elements included in graphic representation 800 may vary from one gaming machine to the next because that particular element is personal to the particular player and gaming machine at which it is displayed. In this particular example, the selectable object set 802 for each gaming machine participating in the prize progression game is personal to that particular gaming machine and associated player. That is, each player participating in the game can only see their respective selectable object set 802. Also, in this example graphic representation 800, prize progression 809 is a personal prize progression. As such, each different graphic 800 displayed at a given gaming machine for a given instance of the prize progression game shows a prize 823 that is personal to that particular player and graphic. Also, the state of the prize progression as indicated by prize progression segments 824 is personal to a particular player and graphic 800 participating in the game. The total credits won meter 830 represents a personal credit value and thus may vary from one gaming machine to the next participating in a given instance of the prize progression game. Finally, multiplayer status indicator graphic 820 varies from one gaming machine to the next in a given instance of the prize progression game to the extent that it is required to convey information personal to the given player such as, for example, a status message 829 (e.g. “Pick a Tile” of “waiting for other players”). The example graphic representation 800 shown in FIGS. 8-11 shows the particular graphic for the player indicated at location 827 and multiplayer status indicator 820.

Elements of graphic representation 800 that are not personal to a given participating player are maintained consistent at each gaming machine participating in a given instance of the prize progression game. The updates in the displays to maintain this consistency are preferably made simultaneously at the respective gaming machines. In the illustrated example game, prize progressions 805, 806, 807, and 808 are all shared prize progressions and are thus maintained consistent from one graphic representation to the next for a given instance of the prize progression game. Also the orientation of each prize progression 805-808 about circle 835 is maintained consistent among the participating gaming machines in this implementation. The bank bonus meter 831 in this embodiment also shows a value that is in a sense shared and thus the state of that meter is maintained consistent for each graphic 800 and gaming machine participating in the given instance of the prize progression game.

According to the rules of the game illustrated through graphic representation 800, one of the prize progressions on the periphery of circle 835 is considered an active prize progression. A shared prize progression aligned on circle 835 must be active in this embodiment in order for a prize progressive affecting element comprising a progress varying value to apply. In this example embodiment the three o'clock position on circle 835 represents the active location and only the prize progression at that location is in an active state.

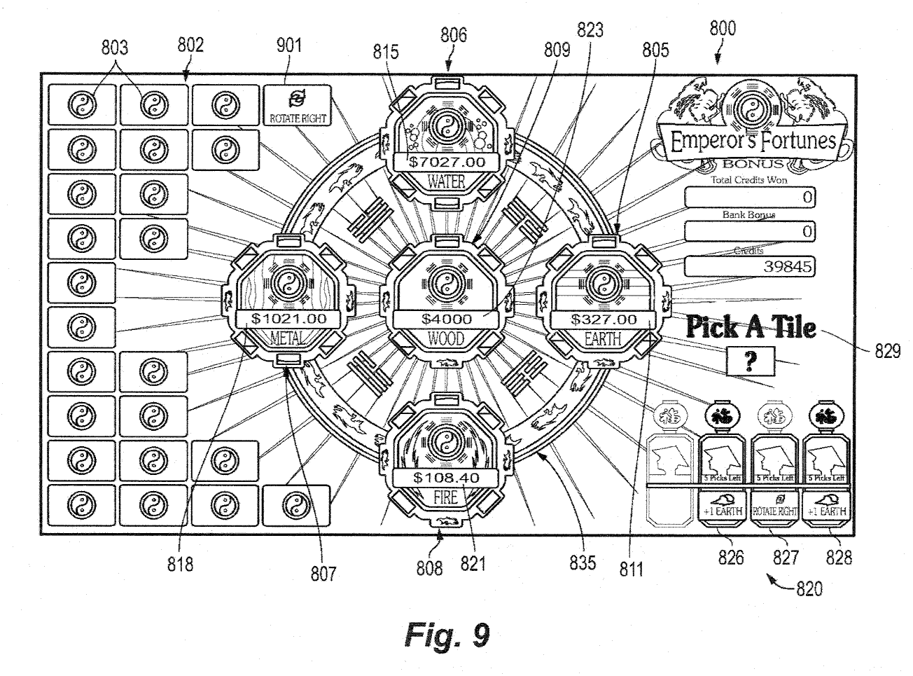

The state of graphic image 800 shown in FIG. 9 indicates that it is the player represented by location 827 who is then enabled to select from their respective selectable object set 802, although they have not yet made a selection. This status is indicated by the highlighted location 827 and the status message 829 “Pick a Tile” requesting that the player pick a respective selectable object from their selectable object set 802. Graphic representation 800 in FIG. 9 also shows that the player associated with location 827 has on a previous turn selected object 901 to reveal a prize progression affecting element “rotate right.” This has caused prize progressions 805-808 aligned along the circle 835 to rotate one position to the right, that is, clockwise. Comparing FIGS. 8 and 9, it is apparent that this right rotation has moved prize progression 805 to the three o'clock position about circle 835. It should also be noted by comparing FIGS. 8 and 9 that the particular prize values or prizes 811, 815, 818, and 821, which represent progressive prizes, have been incremented as additional wagers have been made. It should further be noted by comparing FIGS. 8 and 9 that FIG. 9 shows that the players associated with locations 826 and 828 in multiplayer status indicator 820 have each previously selected objects from their respective object set 802 having the value “+1 Earth” to complete a respective segment for prize progression 805. Finally is noted by comparing FIGS. 8 and 9 that none of the selections made by the three participating players have reduced their number of picks or selections left for the particular prize progression game.

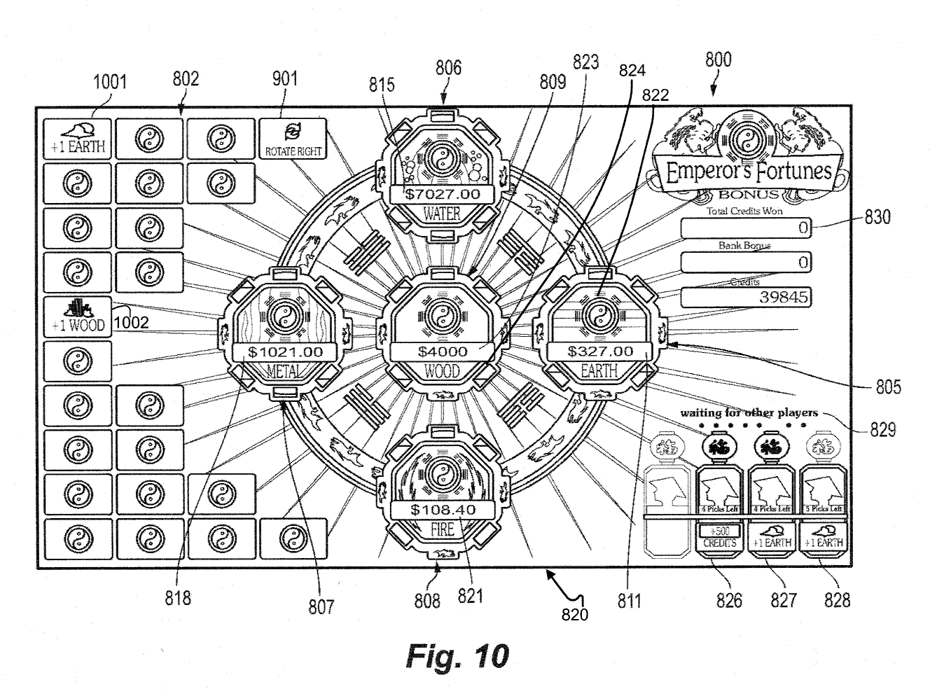

FIG. 10 shows the state of graphic representation 800 after several more turns have been taken among the various players represented by locations 826, 827, and 828 in graphic 820. In particular, the player associated with player locations 827, for which this particular graphic 800 is produced, has most recently picked object 1001 associated with the prize progression affecting element “+1 Earth.” FIG. 10 shows that between all of the selections made by the three players participating in the game, four of the five segments 822 associated with prize progression 805 (the active prize progression) have been completed. The completion of a respective progression segment is shown by the color change of the particular segment shown in the graphic. FIG. 10 also illustrates that the player associated with location 827 of multiplayer status indicator graphic 820 has previously selected object 1002 to reveal a prize progression affecting element comprising a progress varying value “+1 Wood.” This progression varying value has completed one of the segments 824 associated with the centrally displayed prize progression 809 which, as mentioned above, comprises a personal prize progression for the player associated with this particular graphic representation. FIG. 10 also shows that the player associated with location 826 in graphic 820 has most recently selected an object associated with a prize progression affecting element comprising a personal credit value of 500 credits. The graphic representation for this particular player would include this 500 credit amount in the total credits won meter 830 displayed for that player, representing an amount that has been won by the player in the course of the prize progression game. Finally, multiple player status indicator graphic 820 shown in FIG. 10 indicates that the number of selections has been reduced for the players associated with locations 826 and 827 but remains at five selections left for the player associated with location 828. In this form of the invention, only prize progression affecting elements comprising a personal value for that particular player reduce the number of selections left for that player. Prize progression affecting elements comprising a value that varies a shared prize or shared prize progression do not reduce the number of selections left for that player. Thus the player associated with location 828 in FIG. 10 is shown as having five selections left even though they have previously selected objects from their respective selectable object set 802.

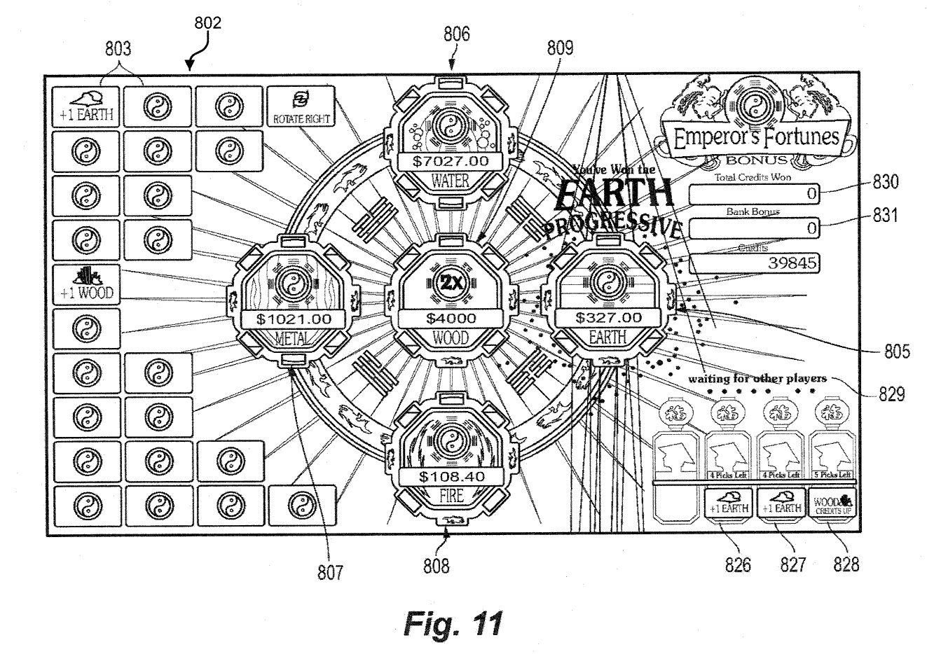

The graphic representation 800 shown in FIG. 11 shows a state in which prize progression 805 has been completed. The player associated with location 826 has just made another selection from their respective selectable object set 802, and has selected an object associated with the prize progression affecting element “+1 Earth” to complete prize progression 805. The completion of this prize progression entitles each of the three players participating in this instance of the prize progression game to share in the prize 811 included for prize progression 805. A comparison of FIG. 11 in FIG. 10 also shows that the various progressive prize values, prizes 811, 815, 818, and 821 have all been increased as additional wagers have been received and the progressive allocation rule applied to distribute fractions of the wager among the progressive prizes. It will also be noted that the personal prize progression 809 for the player associated with location 827 has been modified to show a multiplier value. This multiplier value represents a prize progression affecting element in this form of the invention.

In a preferred implementation of a prize progression game according to the invention even though prize progression 805 has been completed as shown in FIG. 11, the three players participating in the game continue to make selections from their respective selectable object set 802 until no further selections are available. Thus it is possible for each of the players participating in the prize progression game to increase their winnings as they continue to make selections. Players participating in a given instance of the prize progression game also each win any amount shown at the bank bonus meter 831.

In this illustrated implementation of a prize progression game among multiple players according to the present invention, the game is controlled such that each selectable object 803 in selectable object set 802 is mapped to a particular prize progression of affecting element. Thus the player's selections impact the manner in which the game proceeds and the prizes that are collected by the player. The mapping between selectable objects 803 and particular prize progression affecting elements may be made to insure an overall expected prize distribution for the conduct of prize progression games. One preferred form of the invention maintains two sets of prize progression affecting elements, one set including plus credit values, bank credit values, personal progression varying values, and personal progression multipliers, and the other set including rotation values (progress activation modifiers) and progress varying values for the active prize progression. These prize progression affecting elements are selected randomly from these sets for mapping to the various selectable objects 803 for a given player. It will be appreciated however that other forms of the invention may be implemented so that the players' choices do not affect the results and the game. That is, each player participating in a given instance of the prize progression game may be predetermined to have a certain result. In this case the players' selections and the prize progression affecting elements revealed by the various selections are controlled so that the selections ultimately revealed the predetermined prize for each respective player.

The example displays shown in FIGS. 8-11 are shown only as convenient examples for describing the principles of the invention. Many variations on these basic examples may be employed within the scope of the present invention. Numerous variations are possible both in the graphic representation and in the conduct of play. For example, when a player is given a turn to select an object from their respective selectable object set 802, the player may be given a period of time to make a selection. If no selection is forthcoming by the player in that time, the gaming machine or game server may select for the player and then proceed to the next player's turn. Also, the prize progression games may be implemented such that a player can make their next selection at any time, but the selection only becomes effective to reveal a prize progression affecting element only when it next becomes the player's turn to select.

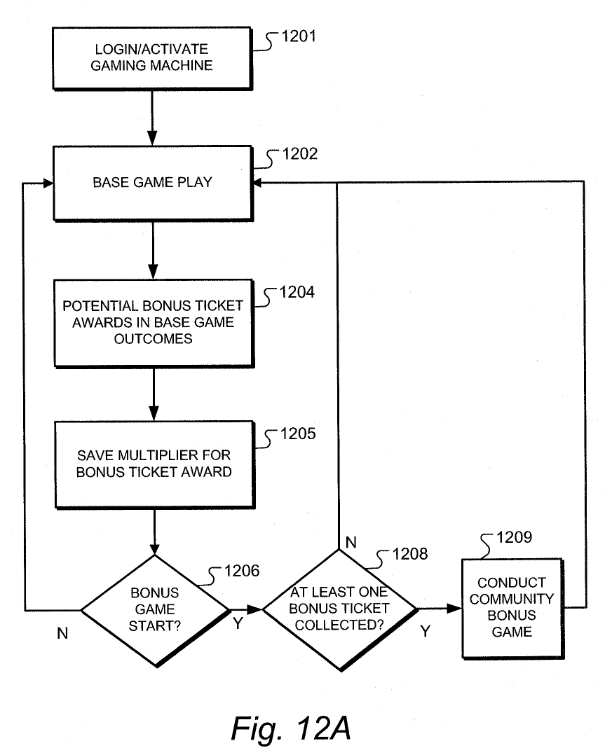

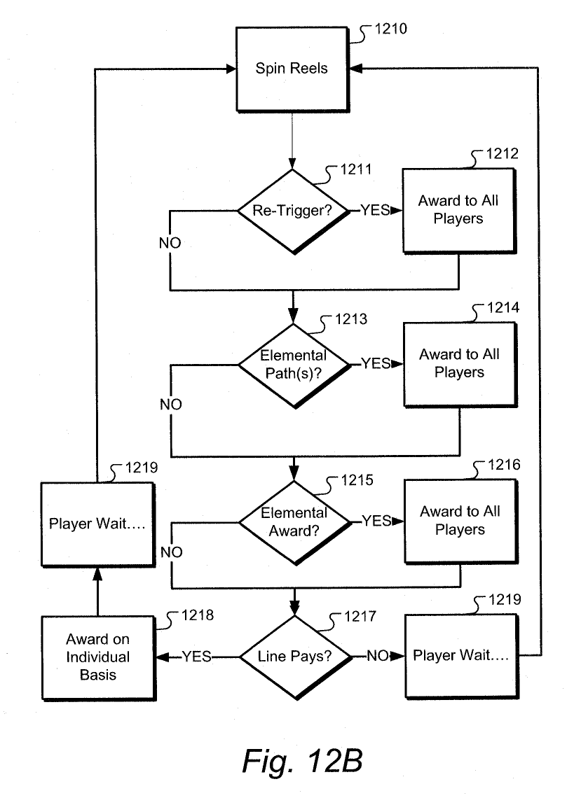

FIG. 12A shows a flow chart of a process, according to another embodiment of the invention, which process may be performed at the various gaming machines 100 included in the gaming system shown in FIG. 3. FIG. 12B shows a flow chart of a general game process for the embodiment in FIG. 12A.

Regarding FIG. 12A, the depicted process illustrates the interaction between a primary game that may be available at a respective gaming machine 100, and a multi-player, community participation bonus game provided through the gaming machine. Once the player logs in at gaming machine 100 or otherwise activates the gaming machine as indicated at process block 1201, the player may make a suitable eligibility input at the gaming machine and enter the base game play shown at step 1202. In this embodiment, the base game play of step 1202 includes outcomes that provide bonus game entry tickets (step 1204), which qualify the player for entry into the bonus game. In this version of the game, to become eligible for the free spin bonus game, called Emperor's Fortunes Free Spin Bonus, players are required to play all lines and place a side bet (for example, an additional 10 to 50 credits). When the side bet is placed, the base game is enabled for a possible outcome of 3 scattered bonus symbols on reels 1, 3, and 5 (which are inactive when the side bet is not placed, active when it is). Such enablement is indicated by step 1204, which provides a bonus game entry ticket based on the presence of the symbols. When an entry ticket is awarded, the player is awarded a multiplier based upon their side bet (step 1205). For example, placing a side bet of 10 credits awards a 1× multiplier, while placing a side bet of 50 credits awards a multiplier of 6×. Normally, the 50 credits side bet would award a 5× multiplier, but to add value to the max side bet placed, the multiplier is increased by 1×.

The multiplier is preferably shown to the player on the game's reel display screen in the upper right corner so they know they are qualified for the bonus event. Every time the player receives a bonus game entry ticket, they receive a multiplier that is added to the current “Bonus Multiplier” value (which preferably starts at no multiplier). Accumulation of these values continues until the bonus is triggered.

Players not making a side bet do not have multipliers that can accumulate, and hence, cannot participate in the Free Spin Bonus. Players can, however, place the side bet, accumulate an entry ticket and a desired multiplier, and then discontinue placing the side bet and still have eligibility for the bonus. Players can also vary their side bet to add different multipliers to their “Bonus Multiplier” meter.

Next, at step 1206, the process determines that it is time for a bonus game to be started. This may occur in a number of ways. As described above with regard to the first embodiment, a server-generated random number may initiate the bonus game. In this embodiment, the preferred initiation method is to conduct a bonus game at regular periodic intervals, as determined by a timer on the server, which in a preferred embodiment is set to 10 minutes. Other embodiments may include a random time elements added to a standard period, so that players cannot predict exactly when a bonus game is to start, but instead can tell that one is “due.” This may be implemented by adding a RNG-based random time period onto a base timer period. Or, a base timer period expiration may activate an RNG process that activates the bonus game on a particular random value. In such case, the probability of the activating value is preferably set higher than the arrangement of the RNG-based system in the first embodiment (which has no periodic timer).

If a bonus game is started as indicated by a positive outcome at decision box 1206, the process proceeds to decision box 1208 where it checks whether any machines are eligible for play in the bonus game—that is, whether they have accumulated one or more bonus entry tickets. If so, the process conducts a bonus game including all eligible machines at step 1209. This bonus game may be a community participation game, in some versions, and in other versions may be a progressive prize game. If no machines are eligible at the process at box 1208, the process returns to base game play mode at step 1202 to await the next bonus game activation.

It will be appreciated by those skilled in the art that eligibility may be handled in a number of ways within the scope of the present invention. Some version may not require a side bet to win bonus game entry tickets and multipliers, but instead may make a given gaming machine eligible in response to a particular bet level in the primary game.

FIG. 12B is a flow chart of a bonus game process according to one embodiment. The objective of the bonus round is to win all of the bagua paths for any bagua (progression affecting elements). When the bonus is triggered, those that have qualified for the bonus all go into the bonus round together. Each player receives 10 free spins to accumulate elemental ‘paths’ for the four elements, in addition to other line pay awards. Each of the elements has a predetermined number of paths that are required to win the award. The awards are represented by elements and follow the ‘creative order’:
“Water”—3000 credits—requires 8 water symbols to win (elemental scatter symbol located on reel 5)
“Metal”—1000 credits—requires 7 metal symbols to win (elemental scatter symbol located on reel 4)
“Earth”—400 credits—requires 6 earth symbols to win (elemental scatter symbol located on reel 3)
“Fire”—150 credits—requires 5 fire symbols to win (elemental scatter symbol located on reel 2)

Each player's spin can produce the following: winning and non-winning combinations, a +1 Water symbol, a +1 Metal symbol, a +1 Earth symbol, a +1 Fire symbol, and/or a re-trigger which awards an additional 5 spins to all players participating in the bonus. The bonus ends when no free spins remain.

Since this is a community game, timing is critical when everyone is playing at once. Therefore, the bonus process is designed in such a way to minimize wait times during each spin. As shown in FIG. 12B, the process starts with a player activating a reel spin at step 1210. This causes the player reels to spin and stop.

At step 1211, the process checks if there is a re-trigger event awarded. If so, at step 1212 a popup banner appears on all players' stations (that are in the bonus), denoting extra spins are awarded, and spins to the spins remaining meter.

Next at step 1213, the process checks if there are elemental paths (progression affecting elements) awarded in the outcome. If so, the process tallies up the total number of those pieces in the message box and awards to all players in the bonus at step 1214.

An element path awarded may complete the bagua or other prize progression and cause a prize to be awarded. The process checks for this at step 1215. If there is a completed prize progression, process award that bonus to all players in the bonus round at step 1216.

Next at step 1217, the process checks for any line pays in the players free spin outcome. If any pays are present, the process awards the line wins for that spin at step 1218. These awards are individual awards specific to the player's free spin outcome, and are not shared with the community. Next the process waits for the next player spin input at step 1219. Of course, the depicted steps may be performed in any suitable order that produces the same outcome for the bonus game play.

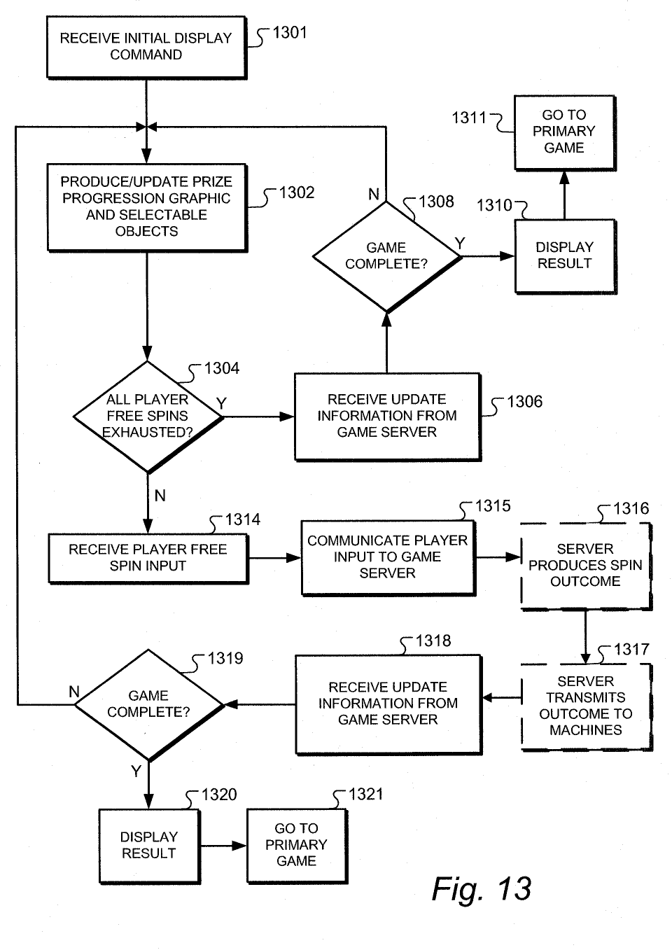

FIG. 13 shows a flow chart of a process that may be performed at a respective gaming machine 100 during the conduct of a prize progression game, whether or not the game conducted is a bonus game as indicated at process block 1209 in FIG. 12A. In this version, the bonus spin outcomes are determined at the system server and the individual gaming machines receive inputs and follow display command scripts to show the outcomes from the server. In other embodiments the gaming machine itself may determine the spin outcome and transmit the results to the server for distribution to the other machines in the bonus round, or transmit directly to the other machines.

In this server-controlled process, the respective gaming machine 100 receives an initial display command at the start of a particular prize progression game. After receiving the initial display command as indicated at process block 1301, gaming machine 100 displays the prize progression graphic and the simulated reel display at the gaming machine as indicated at process block 1302. That is, the respective gaming machine 100 causes the desired display device or devices at the gaming machine to display the prize progression graphics. In this embodiment, a multiplayer status indicator may be used to show how many free spins the other player have remaining.

Next, at step 1304, the process checks if the current player has exhausted all of their free spins. If so, the process goes to step 1306 to receive game status updates that may result from other players' free spins. Once all free spins are complete at step 1308, the process displays the final game result (step 1310) and returns to the primary game (step 1311). If, back at step 1304, the current player has not exhausted their free spins, that decision block proceeds to step 1314 to receive a free spin input from the current player. A similar process is, of course, happening on any other gaming machines participating in the game, with those results being sent to the presently described gaming machine in respective server updates.

After receiving a free spin input, the process communicates the input to the game server at step 1315. In response, the server produces or looks up a spin outcome (step 1316), and transmits the results of that outcome to the participating gaming machines at step 1317. It should be noted that only the progressive shared portion of the result (i.e., the ‘path’ awarded, and any prize award that may result from that path) is transmitted to all participating machines. The reel spin result is, in this embodiment, specific to the requesting machine and transmitted only to that machine. In other embodiments, the reel spin may be commonly displayed at all participating machines. The steps performed by the server in preferred embodiments are depicted in the figure with dotted lines. Details of the transmitted data are further described below.

The gaming machine receives the transmitted update at step 1318. Next, if the game is complete at this point as indicated by a positive outcome at decision box 1319 the gaming machine displays the result for the prize progression game as indicated at process block 1320. Where the prize progression game is being played as a bonus game at the respective gaming machine 100, the process returns to the primary game as shown at process block 1321. If the game is not complete as indicated by a negative outcome at decision block 1319, the process loops back to proceed again through process blocks 1302 to the decision at decision box 1304.

The process shown in FIG. 13 represents one preferred process conducted at a respective gaming machine 100 for an implementation of a prize progression game as implemented through a gaming system as shown in FIG. 3. In this preferred implementation of the invention, the functions of the gaming machine in the prize progression game all relate to producing various displays and modifications to the graphic displays in response to information received from game server 302 (FIG. 3). Other forms of prize progression games within the scope of the present invention may distribute functions differently across the network. In particular, rather than rely exclusively on information provided by game server 302 as indicated in process, the respective gaming machine 100 may generate outcomes and transmit those outcomes to the server, or to other gaming machines in a peer-to-peer arrangement.

In gaming machine process shown in FIG. 13, the respective gaming machine 100 requires information from game server 302 even for player selections made at that particular gaming machine.

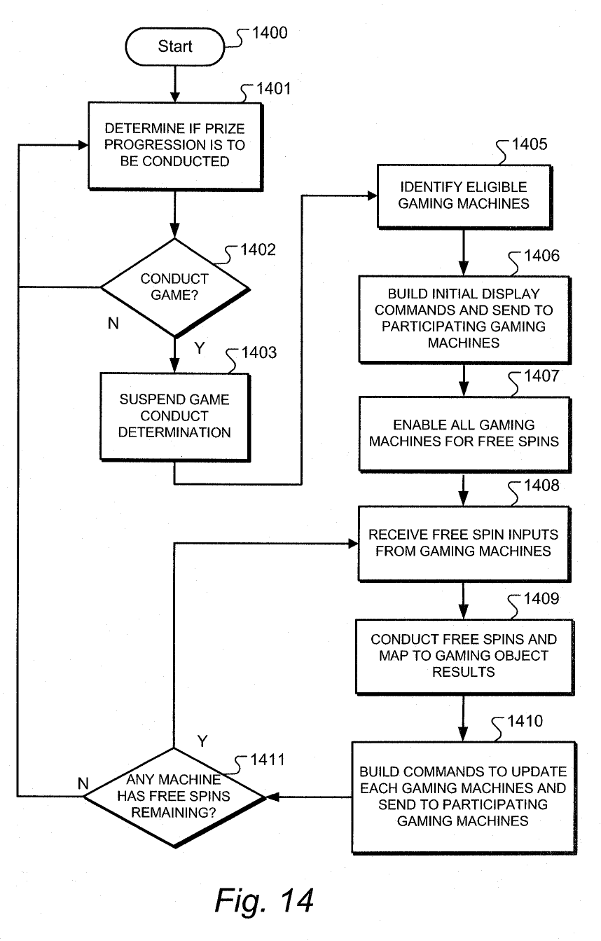

FIG. 14 shows a block diagram of a process that may be performed at game server 302 shown in FIG. 3 according to one preferred form of the invention, and represents the complement to the gaming machine process shown in FIG. 13. The process starts at step 1400 where the game server is provided in its booted and active state. As indicated at step 1401, game server 302 is preferably responsible for tracking the timer and/or other activation function for a prize progression game. In a preferred version, a timer is used to determine that a waiting period is complete and therefore a new game should be attempted. As previously explained, step 1401 may also include random variations to the timer period, preferably variations above the time period, but random time variations may also be produced that shorten the timer period. A negative outcome at decision box 1402 causes the process to loop back to wait for the next determination at process block 1401.

If a prize progression game is to be conducted as indicated by a positive outcome at decision box 1402, the process suspends any further game conduct determinations as indicated at process block 1403. The process then identifies eligible gaming machines as indicated at process block 1405. The eligible machines are those that have collected at least one bonus entry ticket as described above. Those machines are entered in the prize progression game for play, and the others are excluded. Note that the server is preferably configured to serve a designated group of games, so step 1405 does not necessarily check all gaming machines at its gaming facility, but instead checks a designated group of machines, preferably one or more “banks” of machines in a row or group on the facility floor having at least one common display updated with progressive game information.

After identifying eligible machines, at step 1406 the process builds initial display commands and sends the initial display commands to the participating gaming machines. As an alternative, the bonus game display may be a reel game display produced by the gaming machine. As indicated at step 1407, game server 302 causes a respective gaming machine 100 participating in the game to be enabled activating free spins, or other progressive round activities, and then receive such player inputs or activations for these activities at step 1408. At step 1409, in response to receiving player inputs, the server conducts the free spins or other progressive round activities, and determines the results. This process is further described below. In some embodiments, at time-out may also be placed on players to use their free spins to speed progressive round completion. If the timeout occurs, a free spin input (or other progressive activity) is automatically entered for the player in the process step 1408.

For each input that is received from step 1408, the game server 302 conducts the activity at step 1409 and then builds update commands for each participating gaming machine 100 and then causes those update commands to be sent to the respective gaming machines as indicated at step 1410. After the update commands are sent, if further progressive activity inputs are available for any of the participating players, as indicated by positive outcome at decision box 1411, the process loops back to process block 1408 at which point any gaming machines with free spins remaining are still enabled for free spin input. The specific design of this process may vary in different embodiments. For example, some embodiments may send individual update commands for each free spin (progressive activity) input received. Others may group results from those inputs that are received within a particular time of each other, and send them together. Display commands may specify that the player display is updated with one result at a time, even if multiple results are sent in a single display command update. Or, multiple results may display simultaneously to the player, thereby updating the displayed prize progression information with more than one path update at a time.

If no further selections are available as indicated by negative outcome at decision box 1411, the process returns to the step shown at step 1401 to reinitiate the determination step indicated there.

The process shown in FIG. 14 is conducted for a single instance of a prize progression game according to one form of the present invention. That is, this process is performed for each prize progression game that is conducted. Some implementations of the invention allow game server 302 to conduct only one instance of a prize progression game at a time. However, other preferred implementations may allow multiple instance of the prize progression game to be conducted at a given time either up to physical hardware limit or some imposed limit. The determination shown at process block 1401 in FIG. 14 may be made in any suitable fashion. Regardless of the particular implementation, the determination is preferably controlled to evenly distribute prize progression games across some number of gaming machines controlled through game server 302. In other forms of the invention, the determination may be skewed in some fashion to encourage certain conduct by the players through the reward of more frequent participation in prize progression games.

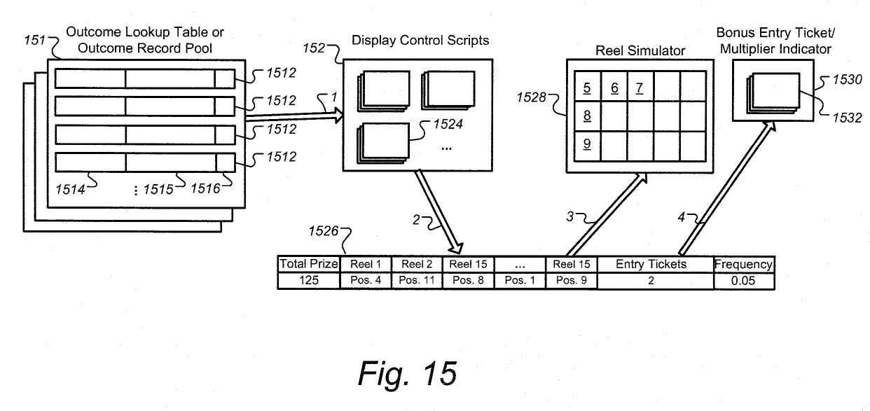

FIG. 15 shows a sequence of data structures that may be used in a bonus game according to some embodiments of the invention. The depicted data structures are used to generate results, display results, and track bonus tickets and multipliers awarded in the base game. This is merely one example implementation, and one of skill in the art will understand from the remaining disclosure that many other implementations are possible to achieve similar results. The arrows in FIG. 15 depict the order in which the various data structures are used during the course of a game. Similar data structures may be used in both the case where the gaming machine produces results for base games played thereon, and where the gaming machine instead sends game play requests to the server, which sends base game results back.

Regardless of where the results are generated, typically the generation follows one of two processes. In the first process, a generated random number is used to index a table and lookup an outcome in the table. In such a version, the outcomes are stored in a lookup table 151 which is indexed by the random number to provide suitable distributed, randomly-selected results. The lookup table has a number of outcome entries 1512, each with an index 1514, a prize amount 1515 in credits, and a progressive entry ticket field 1516. The outcome entry may have other data fields to control other parts of the game. The progressive entry ticket field 1516 indicates whether the record outcome contains one or more progressive game entry tickets.

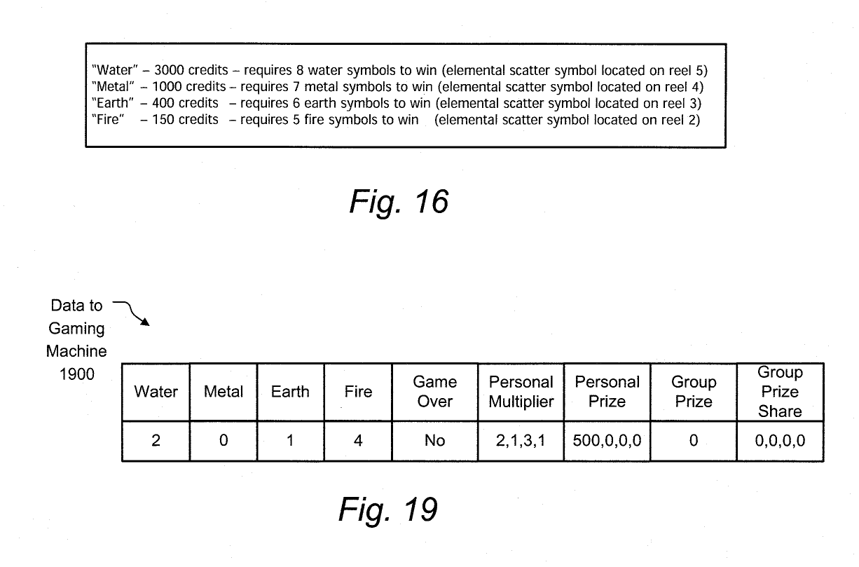

The second available process of game outcome generation, as opposed to a game outcome determined by random number, is to use an outcome record pool of predetermined outcomes in place of the lookup table 151. In those games, an outcome record 1512 (rather than a lookup table entry) is chosen from record pool 151 in response to a game play request. Still other embodiments may use a server-hosted bingo game with multiple game play requests participating as bingo cards, the bingo patterns determining prize outcomes. Referring to an outcome record pool 151, such record pool may be stored at a game server and accessed with game play requests from the gaming machine, or the server may allocate groups of outcome records to be stored and used locally at a gaming machine. (As will be discussed with reference to FIG. 16, a similar but slightly different pool or lookup table is used in a preferred bonus game.) In either case, the depicted game sequence provides an outcome record 1512 in response to a player game play request, such as pushing the spin button to make a wager. An outcome record 1512 is chosen from the pool either randomly or from a randomly-organized queue. The chosen record has a record identifier 1514 (rather than an index 1514 as used in the first embodiment option for FIG. 15), a prize amount 1515 in credits, and a progressive entry ticket field 1516. The outcome record data object may have other data fields to control other parts of the game. The progressive ticket entry field 1516 indicates whether one or more entry tickets are earned for the progressive game. A preferred embodiment displays a designated outcome in the base game to indicate that a progressive entry ticket has been earned. Also, an earned ticket causes a multiplier to be stored based on the value of the player's side bet or bet participation level. The multipliers may accumulate over time.

The preferred process to display base game results is as follows. To start updating the base game display, the gaming machine display controller uses the prize amount field 1515 to select a display control script from a group of scripts 152. This step is indicated by the arrow labeled “1.” The selection process at arrow 1 may be made in any suitable manner that selects a display control script to display the base bonus outcome based on the outcome record. The selected script is used to control the display to provide an exciting series of events in the free-spin bonus round. A preferred control sequence proceeds as follows. The gaming machine presentation controller uses the prize amount 1515 to select a set 1524 of display control scripts from the script group 152. The group 152 has multiple sets. The selected set 1524 includes, in this example version, all display control scripts that have a total prize outcome equal to the prize amount 1515. A separate group may be provided to display entry-ticket winning outcomes for each prize amount, or a separate display area or sequence may be provided for displaying progressive entry ticket winning results. The set 1524 preferably includes many display control scripts that each one uses a different set of reel positions to indicate the total prize amount (assuming a reel-type game is used for the base game—any suitable type of game may be used as the base game without limitation). This helps provide variety and excitement to the game. For example, suppose the selected game outcome entry or record 1512 is a progressive entry ticket-winning result having a prize amount 1515 indicating a 125-credit prize. The display controller looks to the group of display control scripts 152 and finds the set of scripts 1524 that all have a total prize value of 125 credits. The display controller then randomly selects from this set, preferably by generating a random number and using it as an index to identify a particular script. Any suitable random selection or randomization step may be used, or a predetermined sequence may also be used if it is long enough that no pattern is discernible during player use of the gaming machine. In any event, a single display control script 1526 is chosen from the set 1524 for use in displaying the base game results to the player. This is indicated by the arrow marked “2.”

A display control script 1526 chosen at arrow 2 for the free spin bonus round includes, in this version, the depicted data fields. The fields are shown with field name on top and an example value on bottom. Other fields may also be included, and some fields are not absolutely necessary. This version includes the total prize field in the display control script for tracking purposes. The script 1526 contains a reel position field for each reel in the reel-type base game display. These fields indicate the final positions of the reels needed to convey the desired game outcome. The Frequency field indicates a number indicating the hit frequency or probability that this particular script will be selected from the set 1524. The depicted example shows a 0.05 Frequency value, indicating that this script will be shown 5% of the time that a total prize of 125 is awarded in the base game. This hit frequency is preferably controlled through selection by an evenly-distributed random number, but may be enforced by other suitable methods, including random number based methods or methods that rigidly enforce the hit frequency.

The presentation controller employs the script 1526 to control the stop positions of a simulated reel spin. This is designated by the arrow marked “3,” which points to the reel simulator 1528. The simulator 1528 simulates spinning slot-machine reels and displays resulting symbols. Each simulated reel is modeled as a set of reel-symbols arranged in a circle. In the preferred game, one symbol from each simulated reel is shown at a time (although other games may use multi-symbol reels, such as 3 or 5 symbol reel). While the reel simulator may appear to players to be five 3-symbol reels, the simulator actually includes 15 simulated reels, each showing a single position (uni-symbol reels). In the depicted reel simulator 1528, for example, each square 5, 6, and 7 and so on represents a single symbol displayed from a different reel, and squares 8 and 9 and so on also represent a single-symbol reel display. The simulated reels are controlled by their position, which is designated by which symbol place on the reel is presented at the center space in the three vertical symbol spaces shown in the 5 reels.

The reel stop data object is part of script 1526 and contains a reel stop position for each reel in the simulated reel display. In the preferred game, the base has 15 uni-symbol reels, so the reel stop data object stores 15 positions (Reel 1-Reel 15). The presentation controller uses this data to reel stop positions for reel simulator 1528.

Finally, the depicted Entry Tickets field in the reel stop data object in script 1526 contains the number of progressive entry tickets which the player was awarded in the game outcome for which script 1526 was selected. The reel stop data object in script 1526 may also contain other data used by the presentation controller to determine a display sequence to indicate to the player that an entry ticket was awarded. Various sequences may be used to add variety to the game, and more lengthy or involved sequences may be used to convey awards of two or more progressive entry tickets. After any award display sequence, an entry ticket indicator 1530 on the gaming machine display shows that the player has accumulated an entry ticket. The indicator 1530 may have various symbols 1532 to show how many entry tickets have accumulated.

FIG. 16 shows a table of awards according to one embodiment. The names of the various baguas displayed during the progressive game are shown on the left, “Water,” “Metal,” etc. Then the table shows prize value, which is awarded to each participating player should any player spin result in a prize win. Finally, the table shows how many bagua “paths” are needed to win the prize.

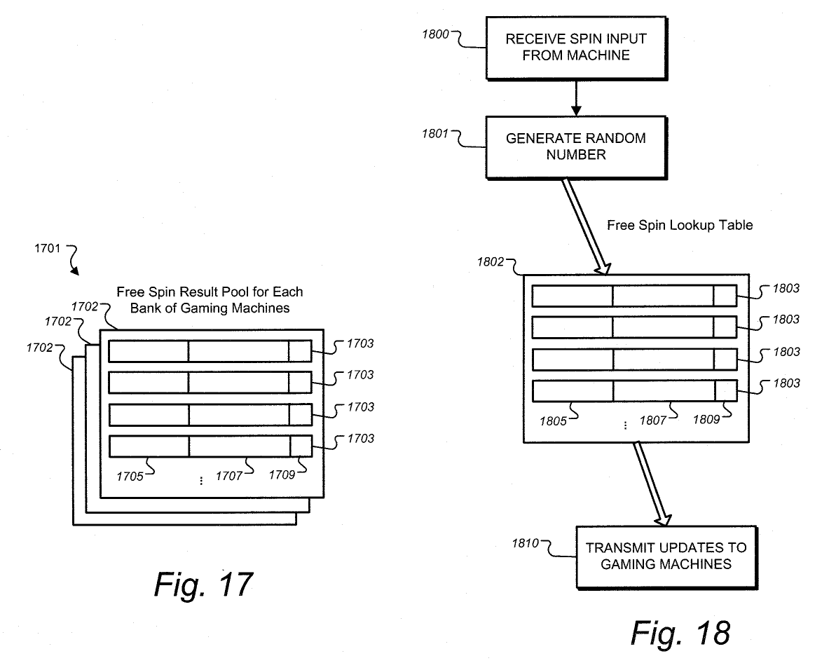

FIG. 17 shows a data structure for a progressive result pool according to one embodiment. In some versions of the game herein, such a pool may be used to determine the free spin outcomes of the progressive game. Each outcome results in one or more bagua paths being filled, thereby moving the players closer to the progressive prize awarded when all the paths are filled on a particular bagua. To conduct the free spins (shown, for example, at 1409 in FIG. 14), the game may use a result pool as depicted in FIG. 17, or a RNG and lookup table, depicted in FIG. 18.

Referring to FIG. 17, a result pool 1701 may generally include a data file or database data table containing records of predetermined results. These are also known as “ticket records,” electronic lotto tickets, or pre-play records, those terms usually being used when referring to base game play, and not to progressive spin type play as is occurring in this context. To use a result pool for progressive spins, a generated random number is employed to index the result pool and lookup a predetermined record. In this embodiment, the outcomes are stored in a result pool 1702 such that, when indexed with a random number, they provide suitable distributed, randomly-selected results. In this case, the result record 1703 includes a record identifier 1705, used to identify and index the record within the pool. It should be noted that some versions use a randomly ordered pool and select the records in order, so no indexing is needed in those cases. The result records 1703 next contain a progressive segment field 1707 for specifying what progressive segments (i.e., the bagua “paths” on the example progressive game display) are provided in that specific result. The result record 1703 may contain zero, one, or more progressive segments. Record 1703 also contains a bonus outcome field 1709, which specifies outcomes such as a “re-trigger” outcome. The re-trigger provides 5 additional spins for the bonus round. The outcome entry may have other data fields to control other parts of the game.

FIG. 18 is a flow chart and diagram of another process for generating free-spin results for the prize progression games described herein. This method uses random numbers to access a result lookup table. Lookup tables are known in the art and may be constructed to provide a determined statistical frequency of any particular outcome in the table. The lookup table 1802 has a number of outcome entries 1803, each with an index field 1805, a progressive segments field 1807. The entries are similar to those in the record pool of FIG. 17, but are accessed by lookup. The index fields typically contain upper or lower ranges into which random numbers fall in order to access that specific table entry. The progressive segments field 1807 contains the progressive segments that are awarded in the progressive game whenever this outcome is selected. Record 1803 also contains a bonus outcome field 1809, which specifies outcomes such as a “re-trigger” outcome. The re-trigger provides 5 additional spins for the bonus round. The outcome entry may have other data fields to control other parts of the game.

The depicted lookup table 1802 is employed to produce an outcome for each free spin request in the prize progression game. Requests are received from the gaming machines at step 1800. The request, in this embodiment, is a free-spin request initiated by a particular player at a machine. After receiving the request, the machine generates a random number with an RNG at step 1801. The random number is used to index the lookup table 1802 and provide an outcome. At step 1810, the provided outcome is transmitted to all the participating gaming machines, in the form of an update.

FIG. 19 shows an example of update data that is transmitted to gaming machines to update their bonus prize progression game status according to one embodiment of the invention. The depicted data structure 1900 is transmitted from the server to the gaming machines after each free spin result is produced. In some embodiments, multiple free spin results may be produced in rapid succession, and the corresponding updates may be transmitted together or combined in a single update transmission. The progressive update data structure 1900 has data fields shown labeled with their name. Of course, designs may vary and data position may be sufficient to identify the field, as is common in data structures. The first four depicted structures show the number of progression segments (i.e. paths) that are completed for each displayed prize progression. The number of paths or progression segments for the community prize progressions, Water, Metal, Earth, and Fire, are shown respectively for one preferred game. Note that this update provides a current state for the game. The update may be time-stamped and individual machines may be required to confirm receipt of the update. In this embodiment, the update is cumulative and shows the present state of the progressive game.

The prize progression update data structure 1900 also includes an indication of whether the bonus game is over. This Game Over field typically becomes positive when all the free spins, or other activations in other game designs, have been used up by the players. The Game Over may also be activated in some cases when a major prize is won, such as the higher-value Water or Metal progressive prizes in FIG. 16. Data structure 1900 also contains a Personal Multiplier field specific to each game in play, indicating the accumulated multiplier value that a particular player had when the bonus game started. In preferred embodiments this number acts as a multiplier for any prize allocated to that player in the bonus game. The Personal Prize field contains an indicator of what amount personal prize has been won at each participating machine. In the example values shown, only one machine has won a prize of 500 credits. Some embodiments may not have any personal prizes, but instead make every prize-winning outcome in the bonus game a group prize. The Group Prize field whether the participating group of machines has won a bonus prize and what amount. The Group Prize Share field contains the participating machines' individual shares of any group prize that is awarded. The depicted data structure is only an example, and many different designs may be used to accomplish the techniques in the present invention.

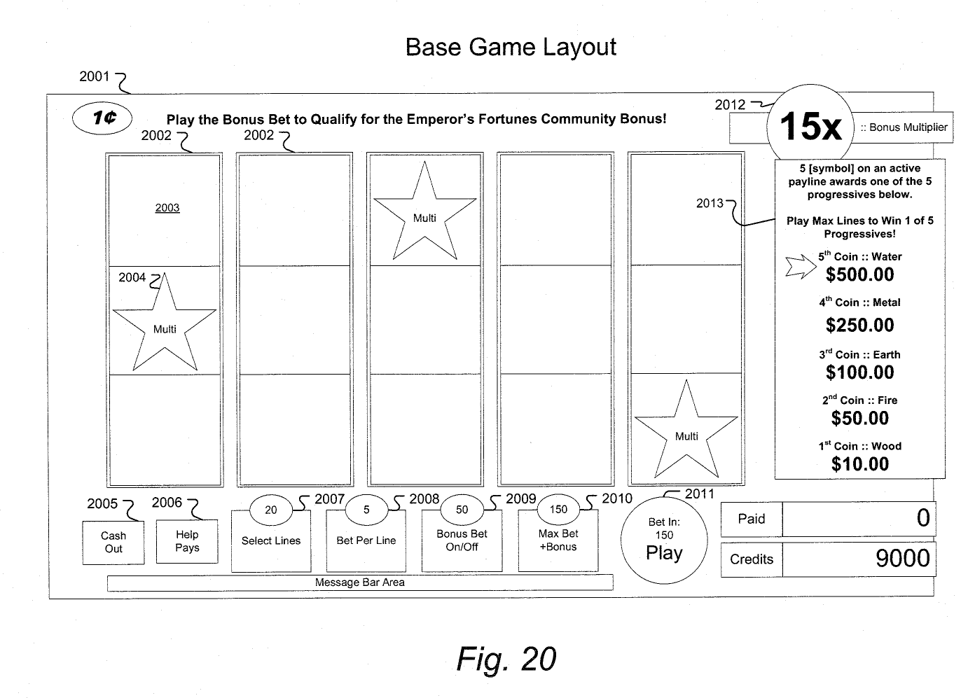

FIG. 20 is a layout of a game screen for a reel-type base game according to the second embodiment described herein. The depicted screen 2001 shows the base game play with five simulated reel columns 2002. These simulated reels may include single-symbol (uni-symbol) reel simulators for each symbol position 2003, or may include three symbols per reel or other combinations and numbers of symbol positions. Uni-symbol reels are preferred for variability.

The preferred game show in FIG. 20, a reel-type wagering game with a bonus game as described herein and a progressive prize available in the base game. The progressive awards are won by achieving 5 symbols of the progressive type, equating to the bagua ‘paths’. Another scatter symbol is the bonus ticket entry symbol, which in this game awards a bonus ticket entry when three of the symbols appear while a bonus bet 2009 is made. The multiplier 2012 is provided with such award, and depends on the bonus bet size as described above. Other game buttons 2005-2011 provide the remaining player interface functionality.

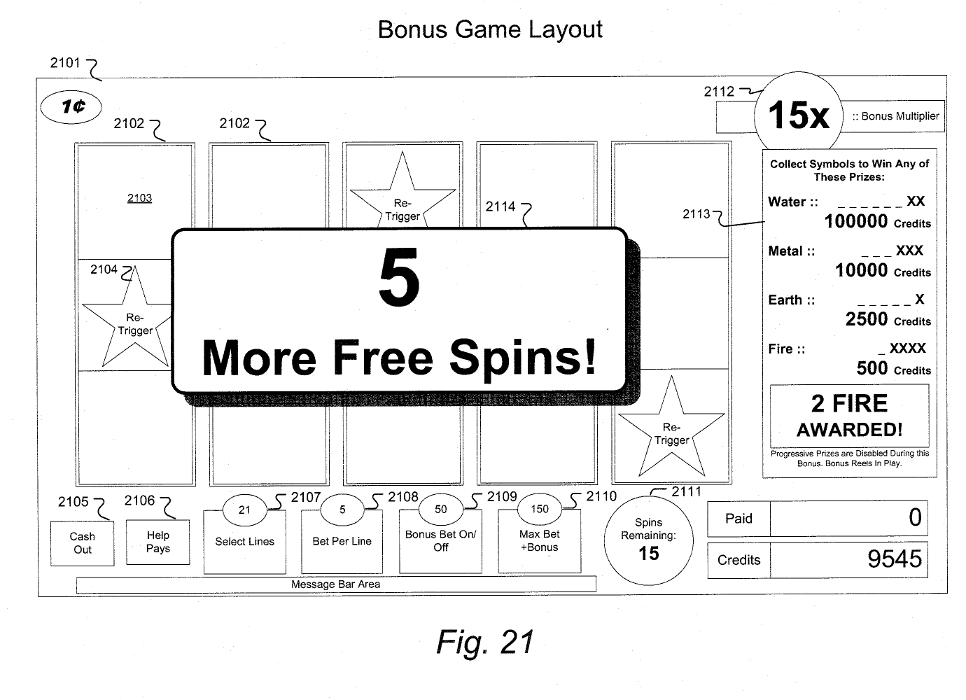

FIG. 21 is a layout of a game screen for a reel-type prize progression bonus game according to the second embodiment described herein. The depicted screen 2101 includes reel simulator arranged in columns 2102, having multiple symbol locations 2103. The reels simulators may be uni-symbol or multi-symbol, and may be of any suitable number. The preferred game has 15 uni-symbol positions as shown. The depicted screen is shown with 3 “re-trigger” symbols 2104 having activated an additional free spin award 2114 for all participants in the bonus game. Also, as indicated in the prize progression display 2113, two fire path elements have been awarded. The depicted prize progression display may display in table form as shown, or may display bagua graphics similar to those described above with regard to the first embodiment herein.

The base game display shown in FIG. 20 includes a defined set of reel symbols, and the bonus game display a different set, with some common symbols between the two. The symbols and their application in the game are as follows.

TABLE 1
Reel Symbol List
Reel Symbol List

Base Game:

Special Symbols:

Progressive Symbol - awards progressive (all 5 reels)
Scatter Symbol - 3 triggers scatter bonus (scattered 1-5);
pick 1 of (up to 5) for award.
Wood - awards multiplier/qualifies player for
community bonus (scattered 1, 3, 5)

High Pays:

Logo
Water
Metal
Earth

Medium Pays:

Fire
A
K

Low Pays:

Q
J
10
9

Bonus Game:

Special Symbols:

Water - single symbol “piece” award (reel 5);
becomes wild when award given.
Metal - single symbol “piece” award (reel 4);
becomes wild when award given.
Earth - single symbol “piece” award (reel 3);
becomes wild when award given.
Fire - single symbol “piece” award (reel 2);
becomes wild when award given.
Wood - Wild (reel 1)

High Pays:

Logo
Water
Metal
Earth

Medium Pays:

Fire
A
K

Low Pays:

Q
J
10
9

It should be noted that the second embodiment described herein with respect to FIGS. 12-21 is preferred to be a server-based game with the server managing the bonus round, this is not limiting and many other implementations are possible. For example, one version may provide that the gaming machine manages base game and bonus game play, and sends updates either directly to its peer machines or to the server acting in a coordinating role.

As used herein, the terms “comprising,” “including,” “carrying,” “having,” “containing,” “involving,” and the like are to be understood to be open-ended, that is, to mean including but not limited to.

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

1. A method of displaying a respective gaming result for one or more players each participating in a game through a respective gaming machine, the method including:
(a) displaying a prize progression graphic at one or more gaming machines, each gaming machine being associated with a different player, the prize progression graphic including a number of prize progressions with each respective prize progression being associated with a respective prize and a respective set of progression segments, the prize progression graphic also including one respective prize progression in an active state;
(b) displaying a number of selectable objects at each respective one of the one or more gaming machines, each selectable object concealing a respective prize progression affecting element and each respective prize progression affecting element comprising either a progress varying value or a progression activation modifier;
(c) enabling each player in turn to select one of the selectable objects displayed at their respective gaming machine, and in response to the player selection of a respective selectable object, revealing the respective prize progression affecting element associated with the respective selectable object and modifying the prize progression graphic such that, for each revealed progress varying value the prize progression graphic is modified by varying the progress in the respective progression segments for the respective prize progression in the active state, and such that for each revealed progression activation modifier the prize progression graphic is modified by changing the respective prize progression in the active state; and
(d) awarding to each player a respective share of the respective prize associated with each prize progression for which progress in the respective progression segments is completed at a termination of player selections.

2. The method of claim 1 further including detecting a triggering event to initiate the step of displaying the respective game result for the number of players.

3. The method of claim 2 wherein the triggering event comprises a game play determination made by a server in communication with each of the one or more gaming machines.

4. The method of claim 1 wherein at least one respective prize comprises a progressive prize that is funded by a side bet which makes a respective gaming machine eligible for the process of elements (a) through (d) of claim 1.

5. The method of claim 1 wherein each player is enabled to make a specified number of selections of the objects displayed at their respective gaming machine, each player making a single selection in turn until selection termination represented by the state in which each player has made the specified number of selections.

6. The method of claim 5 wherein a selection of at least one selectable object associated with a progress varying value does not reduce the specified number of selections for the respective player.

7. The method of claim 1 wherein a side bet adds time to a countdown timer for a respective one of the gaming machines and wherein the respective gaming machine is eligible for the process of elements (a) through (d) of claim 1 for a game triggering event occurring while time remains on the countdown timer.

8. The method of claim 1 further including displaying an additional selectable object at each respective gaming machine, the additional selectable object concealing an additional prize progression affecting element comprising a progress varying value for a personal prize progression displayed at a respective one of the one or more gaming machines.

9. The method of claim 1 wherein the prize progression graphic includes a respective personal prize progression for each respective gaming machine, with each respective personal prize progression being associated with a respective prize value and a respective set of progression segments and further including displaying an additional selectable object at each respective gaming machine, the additional selectable object concealing an additional prize progression affecting element comprising either a personal credit prize, a bank credit prize, or a progress varying value for a personal prize progression.

10. The method of claim 1 wherein the selectable objects displayed at each of the one or more gaming machines are displayed in a random arrangement.

11. A gaming system including:
(a) a number of gaming machines, each gaming machine including (i) a display arrangement having one or more display devices, and including (ii) a player input device arrangement having one or more player input devices;
(b) a game controller arrangement for (i) causing the display arrangement for one or more of the number of gaming machines to display a prize progression graphic, the prize progression graphic including a number of prize progressions with each respective prize progression being associated with a respective prize and a respective set of progression segments, the prize progression graphic also including one respective prize progression in an active state, for (ii) causing the display arrangement for the one or more of the number of gaming machines to display a number of selectable objects, each selectable object concealing a respective prize progression affecting element and each respective prize progression affecting element comprising either a progress varying value or a progression activation modifier, and for (iii) enabling a player at each of the one or more gaming machines to select in turn one of the selectable objects displayed at their respective gaming machine, and in response to the player selection of a respective selectable object, revealing the respective prize progression affecting element associated with the respective selectable object and modifying the prize progression graphic such that, for each revealed progress varying value the prize progression graphic is modified by varying the progress in the respective progression segments for the respective prize progression in the active state, and such that for each revealed progression activation modifier the prize progression graphic is modified by changing the respective prize progression in the active state; and
(c) an award controller for awarding to each player a respective share of the respective prize associated with each prize progression for which progress in the respective progression segments is completed at a termination of player selections.

12. The gaming system of claim 11 wherein the game controller arrangement includes:
(a) a game server in communication with each of the one or more gaming machines for generating display control commands and communicating the display control commands to each of the one or more gaming machines; and
(b) a respective client component at each of the one or more gaming machines for responding to the respective display control commands communicated to the respective gaming machine.

13. The gaming system of claim 11 wherein the gaming controller arrangement is further for enabling each of the players to make a specified number of selections of the objects displayed at their respective gaming machine, each player making a single selection in turn until selection termination represented by the state in which each player has made the specified number of selections.

14. The gaming system of claim 11 wherein the gaming controller arrangement is further for receiving a side bet for a respective one of the gaming machines and in response adding time to a countdown timer for the respective one of the gaming machines and wherein the respective gaming machine is eligible for the process of elements (i) through (iii) of claim 11 for a game triggering event occurring while time remains on the countdown timer.

15. The gaming system of claim 11 wherein the prize progression graphic includes a respective personal prize progression for each respective gaming machine, with each respective personal prize progression being associated with a respective prize value and a respective set of progression segments and wherein the game controller is further for displaying an additional selectable object at each respective gaming machine, the additional selectable object concealing an additional prize progression affecting element comprising either a personal credit prize, a bank credit prize, or a progress varying value for a personal prize progression.

16. A program product embodied in one or more computer readable media, the program product including:
(a) prize progression display program code executable for causing a display arrangement for one or more of a number of gaming machines to display a prize progression graphic, the prize progression graphic including a number of prize progressions with each respective prize progression being associated with a respective prize and a respective set of progression segments, the prize progression graphic also including one respective prize progression in an active state;
(b) selectable object display program code executable for causing the display arrangement for the one or more of the number of gaming machines to display a number of selectable objects, each selectable object concealing a respective prize progression affecting element and each respective prize progression affecting element comprising either a progress varying value or a progression activation modifier
(c) player selection program code executable for enabling a player at each of the one or more gaming machines to select in turn one of the selectable objects displayed at their respective gaming machine;
(d) game controller program code executable for responding to the player selection of a respective selectable object, revealing the respective prize progression affecting element associated with the respective selectable object and modifying the prize progression graphic at each of the one or more of the number of gaming machines such that, for each revealed progress varying value the prize progression graphic is modified by varying the progress in the respective progression segments for the respective prize progression in the active state, and such that for each revealed progression activation modifier the prize progression graphic is modified by changing the respective prize progression in the active state; and
(e) award program code executable for awarding to each player a respective share of the respective prize associated with each prize progression for which progress in the respective progression segments is completed at a termination of player selections.

17. The program product of claim 16 wherein the game controller program code further comprises:
(a) a game server program module in communication with one or more gaming machines and executable for generating display control commands and communicating the display control commands to each of the one or more gaming machines; and
(b) a respective client program module at each of the one or more gaming machines executable for responding to the respective display control commands communicated to the respective gaming machine.

18. The program product of claim 16 wherein the gaming controller program code is further executable for enabling each of the players to make a specified number of selections of the objects displayed at their respective gaming machine, each player making a single selection in turn until selection termination represented by the state in which each player has made the specified number of selections.

19. The program product of claim 16 wherein the gaming controller program code is further executable for receiving a side bet for a respective one of the gaming machines and in response adding time to a countdown timer for the respective one of the gaming machines and wherein the respective gaming machine is eligible for the process of elements (a) through (e) of claim 16 for a game triggering event occurring while time remains on the countdown timer.

20. The program product of claim 16 wherein the prize progression graphic includes a respective personal prize progression for each respective gaming machine, with each respective personal prize progression being associated with a respective prize value and a respective set of progression segments and wherein the game controller is further for displaying an additional selectable object at each respective gaming machine, the additional selectable object concealing an additional prize progression affecting element comprising either a personal credit prize, a bank credit prize, or a progress varying value for a personal prize progression.
